(19) United States
(12) Patent Application Publication
(10) Pub. No.: US 2026/0260660 A1
(43) Pub. Date: Sep. 3, 2026

(54) SECURE AUDIO PAIRING FOR ELECTRONIC DEVICES

(71) Applicant: Apple Inc., Cupertino, CA (US)

(72) Inventors: Sean A. RAMPRASHAD, Los Altos, CA (US); Brett D. GEORGE, Los Altos, CA (US); Akash BATCHU PRITHVI, Gilroy, CA (US); Baptiste P. PAQUIER, Saratoga, CA (US); D J CAPELIS, San Francisco, CA (US); Martin E. JOHNSON, Los Gatos, CA (US); David M. TREMBLAY, Boulder, CO (US); Michael C. FRIEDMAN, Nederland, CO (US)

(21) Appl. No.: 19/464,526

(22) Filed: Jan. 29, 2026

Related U.S. Application Data
(60) Provisional application No. 63/757,771, filed on Feb. 12, 2025.

(51) Int. Cl. G10L 19/018; G10L 19/16; H04W 12/50

(52) U.S. Cl. CPC G10L 19/018; G10L 19/167; H04W 12/50

(57) ABSTRACT

Aspects of the subject technology relate to electronic devices having speakers and that are capable of pairing with other electronic devices. An electronic device may pair with another electronic device using an audio pairing signal from a speaker of the electronic device. The electronic device may also detect and alter or destroy attempts to emit spoofed audio pairing signals using the speaker of the electronic device.

### CROSS REFERENCE TO RELATED APPLICATIONS

This application claims the benefit of priority to U.S. Provisional Patent Application No. 63/757,771, entitled, "Secure Audio Indicators for Electronic Devices", filed on February 12, 2025, the disclosure of which is hereby incorporated herein in its entirety.

### TECHNICAL FIELD

The present description relates generally to electronic devices, including, for example, secure audio pairing for electronic devices.

### BACKGROUND

Electronic devices are often provided with cameras and microphones, with which images, video, and audio can be captured. An indicator light is typically included at or near the camera, and activated to indicate that video or audio is being recorded. Some electronic devices use microwave communications to pair with other electronic devices, to enable communications between the paired devices.

### BRIEF DESCRIPTION OF THE DRAWINGS

Certain features of the subject technology are set forth in the appended claims. However, for purpose of explanation, several aspects of the subject technology are set forth in the following figures.

FIG. 1 illustrates an example physical environment that includes an electronic device having a speaker and an input component in accordance with various aspects of the subject technology.

FIG. 2 illustrates a schematic block diagram of an example electronic device having a speaker and an input component in accordance with various aspects of the subject technology.

FIG. 3 illustrates a schematic block diagram of an example electronic device having a speaker, a secure microphone, and an input component in accordance with various aspects of the subject technology.

FIG. 4 illustrates a schematic block diagram of an example secure audio processor in accordance with various aspects of the subject technology.

FIG. 5 illustrates a schematic block diagram of another example secure audio processor in accordance with various aspects of the subject technology.

FIG. 6 illustrates a schematic block diagram of an example device having a secure audio processor and a secure audio input processor in accordance with various aspects of the subject technology.

FIG. 7 is a flow chart of illustrative operations that may be performed for providing secure audio indicators in accordance with various aspects of the subject technology.

FIG. 8 is a flow chart of other illustrative operations that may be performed for providing secure audio indicators in accordance with various aspects of the subject technology.

FIG. 9 is a flow chart of illustrative operations that may be performed secure monitoring for audio indicators in accordance with various aspects of the subject technology.

FIG. 10 illustrates a schematic block diagram of another example secure audio processor in accordance with various aspects of the subject technology.

FIGS. 11A and B illustrate example spectrograms of an audio signal before and after modification of a portion of the audio signal in accordance with various aspects of the subject technology.

FIG. 12 illustrates an example of a secure audio processor configured to switchably bypass a masking operation accordance with various aspects of the subject technology.

FIG. 13 illustrates an example of a secure audio processor configured to switchably turn a masking operation on and off accordance with various aspects of the subject technology.

FIG. 14 is a flow chart of illustrative operations that may be performed secure audio pairing in accordance with various aspects of the subject technology.

FIG. 15 illustrates a flowchart of an example process that may be performed by an application for controlling an electronic device to perform a method in accordance with one or more implementations of the subject technology.

FIG. 16 illustrates a flowchart of another example process that may be performed by an application for controlling an electronic device to perform a method in accordance with one or more implementations of the subject technology.

FIG. 17 illustrates a device in accordance with one or more implementations of the subject technology.

FIG. 18 illustrates a system in accordance with one or more implementations of the subject technology.

FIG. 19 illustrates a ladder diagram corresponding to the operations of FIG. 15 in accordance with one or more implementations of the subject technology.

FIG. 20 illustrates a ladder diagram corresponding to the operations of FIG. 16 in accordance with one or more implementations of the subject technology.

FIG. 21 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details.

In some instances, well-known structures and components are shown in block diagram form in order to avoid obscuring the concepts of the subject technology.

Electronic devices, including portable electronic devices such as mobile phones, portable music players, tablet computers, laptop computers, wearable devices such as smart watches, smart glasses, head mountable devices (HMDs), headphones, earbuds, other wearable devices, and the like, often include one or more input components, such as microphones and/or cameras.

In some devices, a visual indicator, such as an indicator light, is provided that can be activated when an input component is in use, to indicate (e.g., to the user of the device and/or to others around the device) that audio and/or video recording is in progress. However, in some devices (e.g., compact devices with limited housing space), it may be impractical to provide an indicator light, and/or to provide an indicator light in a way that a user of the device (e.g., and/or others) can see the indicator light when activated. For example, when a device is worn on a user's wrist or close to the user's eyes, it can be difficult to locate the indicator light in a location that is readily visible to the user. In some use cases, whether or not an indicator light is provided, the indicator light may not be the most effective way to indicate that an input component is in use. For example, an audio and/or haptic indicator may be more effective at providing an indication than an indicator light, such as for sight-impaired people.

In accordance with one or more implementations of the subject technology, a first audio indicator may be output, by a speaker of a device, that indicates that one or more input components of the device are in use. A second audio indicator may be output, by the speaker of the device, that indicates that the one or more input components are no longer in use. Aspects of the subject disclosure can help to securely ensure that the first audio indicator is, in fact, output by the speaker of a device when one or more input components are activated, and/or that the second audio indicator is not output by the speaker (e.g., spoofed) while the input component(s) are still in use.

For example, the first and second audio indicators may be generated in a way that prevents the first audio indicator being blocked from output and/or prevents the second audio indicator from being replicated or spoofed (e.g., by malware or a third party application running on a device). In this way, secure audio indicators may be provided.

In one or more implementations, such secure audio indicators may be generated by a secure audio processor that controls the output of a speaker of the device. For example, the hardware of the device may be configured such that only the secure audio processor (e.g., and not a main processor of the device) is communicatively coupled to the speaker. In this way, any spoofed version of the audio indicator can be removed by the secure audio processor before the spoofed version can be output by the speaker. As examples, the secure audio indicator may include a low-frequency (e.g., less than 100 Hz and/or sub-sonic) output generated by the secure audio processor, or a spatialized audio output, spatialized by the secure audio processor to be perceived at a particular location relative to a user/wearer of the device. In one or more implementations, a secure microphone can be used to confirm that an audio indicator was output as intended. For example, a secure microphone can be provided by providing a direct (e.g., untamperable) path from a microphone to a secure audio input processor that performs the confirmation that the audio indicator was output as intended.

As discussed in further detail hereinafter, the presence of a secure audio processor that controls the output of a speaker of the device (e.g., in which the hardware of the device may be configured such that only the secure audio processor is communicatively coupled to the speaker) may facilitate other secure audio functions by a device, such as secure audio pairing operations. For example, an electronic device may be provided with the ability to generate an audio output that includes encoded information, such as an encoded passcode, credential, authorization information, or pairing information, in a way that prevents malware (or a third party application) running on the electronic device from generating a spoofed audio output with other encoded information. For example, in a normal operating scenario, with a valid passcode from a valid source, the audio output including the encoded information may be generated by a secure audio processor that controls the output of a speaker of the device. If another (e.g., non-secure) process at the device attempts to output audio with encoded information, the secure audio processor may modify at least some of the audio signal before all of the encoded information can be successfully output by the speaker.

For example, the secure audio processor may include a detector that mimics at least a portion of a decoder of a receiving device for the encoded information. The detector may detect a first portion of a non-secure audio signal that indicates that encoded information, and/or information which could be interpreted as encoded information, is about to be emitted by the speaker, and may cause the secure audio processor to modify at least part of a second portion of the non-secure audio signal to modify the encoded information (e.g. and/or audio-formatting information, such as one or more acoustically encoded confirmation pulses) before the second portion of the non-secure audio signal is emitted by the speaker of the electronic device. Modifications to the encoded information and/or the audio-formatting information can include, but are not be limited to, suppressing time and frequency localized areas of the signal (e.g. through an adaptive filter), adding to the signal to change how the encoded information is interpreted, non-linear modification of the signal such as modifying high and low portions of signal samples differently, and/or timing changes such as shifting in time or phase distortions.

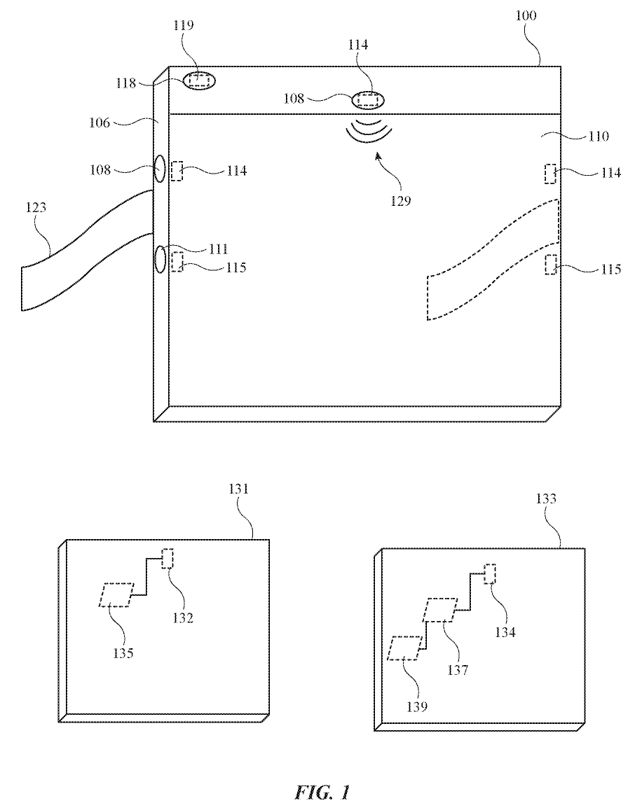

An illustrative electronic device including a speaker and one or more input components is shown in FIG. 1. In the example of FIG. 1, electronic device 100 has been implemented using a housing that is sufficiently small to be portable and carried or worn by a user. For example, electronic device 100 of FIG. 1 may be a handheld electronic device such as a tablet computer, a cellular telephone or smart phone, a wearable device such as a smart watch, smart glasses, a head mountable device (H[MD), a pendant device, a headlamp device, or the like. In the example of FIG. 1, electronic device 100 includes a display such as display 110 mounted to a housing 106 (e.g., a frame). Electronic device 100 may include one or more input components, such as a touch screen incorporated into display 110, a button, a switch, a dial, a crown, one or more microphones 115, one or more cameras such as camera 119, and/or other input components. The input components may be disposed on or behind the display 110 and/or on, within, or behind portions of housing 106. Display 110 and/or housing 106 may include one or more openings to accommodate one or more buttons, speakers, microphones, light sources, and/or cameras (as examples). In various implementations, display 110 may be an opaque display or a transparent display (e.g., a display through which a user can directly view their physical environment, and on which display content can be displayed and/or projected, such as to appear in combination with the user's direct view of the physical environment).

In the example of FIG. 1, housing 106 (e.g., a frame and/or an enclosure) includes openings, such as openings 108, openings 111, and/or opening 118. For example, openings 108 may form ports for one or more respective speakers 114. In the example of FIG. 1, the openings 108 form speaker ports for speakers 114 disposed within the housing 106. In one or more implementations, one or more of the speakers 114 may be secure speakers, as discussed in further detail hereinafter.

In various implementations, the housing 106 and/or the display 110 may also include other openings, such as openings for one or more input components, such as one or more microphones 115, one or more pressure sensors, one or more cameras 119 (e.g., visible light cameras, infrared cameras, color imagers, monochrome imagers), depth sensors, and/or or other components that receive and/or provide signals from and/or to the environment external to the housing 106. In the example of FIG. 1, the openings 111 form ports for respective microphones 115. In one or more implementations, one or more of the microphones 115 may be secure microphones, as discussed in further detail hereinafter. In the example of FIG. 1, the opening 118 forms a port for a camera 119. Some input components, such as microphone(s) 115 and/or camera 119 may have the ability to capture, record, and/or store information from the environment around the electronic device 100. In one or more implementations, one or more of the speakers 114 may be used to securely generate an audio output 129 that includes an audio indicator (e.g., a chime, a ding, a click, or other predetermined notification sound) to indicate when one or more of the microphone(s) 115 and/or the camera 119 begin or end capturing information.

Because the information captured by the microphone(s) 115 and/or camera 119 can include private and/or personal information about the user and/or other people around the electronic device 100, it may be desirable to be able to securely control and/or confirm the output of these audio indicators, as discussed in further detail hereinafter.

Moreover, it may be desirable to prevent unauthorized pairing of the electronic device 100 with other electronic devices, such as an electronic device 131 or an electronic device 133, using an audio output from the electronic device 100, such as the audio output 129. For example, the electronic device 100 may, in some implementations, be configured to include encoded information, such encoded pairing information (e.g., a numerical, alphanumeric, or other form of a passcode, credential, or other authorization and/or pairing information) in the audio output 129, for pairing the electronic device with another electronic device, such as the electronic device 131 (e.g., an audio output device, such as a speaker, a smart speaker, headphones, or earbuds, another media output device, such as a television, a monitor, or the like, or a companion device, such as a smartphone or a tablet device, which may have more power, processing, and/or communications capabilities than the electronic device 100). The electronic device 131 may include a microphone 132 for receiving the audio output 129, and may include processing circuitry configured execute a decoder 135 to decode encoded pairing information in microphone signals from the microphone 132 and corresponding to the audio output 129, and to use the pairing information for pairing the electronic device 131 with the electronic device 100. For example, this audio encoding/decoding sequence may be a part of a direct device attestation process between the two devices. Once paired using the encoded pairing information in the audio output 129, the electronic device 100 and the electronic device 131 may exchange information wirelessly (e.g., using electromagnetic signals, such as a Bluetooth or WiFi signals). For example, the electronic device 100 may be able to receive audio data captured by the microphone(s) 132 of the electronic device 131.

These audio-based pairing operations can be legitimately performed by the electronic device 100 and the electronic device 131 when a user of the electronic device 100 and/or the electronic device 131 approves of the pairing. However, because the audio output 129 is not secure once leaving the speaker 114, malicious software (e.g., on the electronic device 100 or another device, such as the electronic device 133) may be able to capture the audio output 129 and derive the audio format in which the electronic device 131 expects to receive encoded pairing information. The malicious software on the electronic device 100 can reproduce that derived audio format to attempt an illegitimate pairing (e.g., a pairing of which the user of the electronic device 100 and/or the electronic device 131 does not approve, of which the user of the electronic device 100 and/or the electronic device 131 is not aware, and/or of which the operating system of the electronic device 100 is not aware) of the electronic device 100 with the electronic device 131.

Because an illegitimate pairing of the electronic device 100 and the electronic device 131 may give malicious software at the electronic device 100 the ability to access microphones 132, cameras, other hardware features, and/or software features (e.g., including information stored in memory) at the electronic device 131, it may be desirable to be able to securely control the ability of the speaker 114 to include encoding information in the audio output 129, as discussed in further detail hereinafter. Securely controlling the ability of the speaker 114 to include, and exclude or modify in whole or in part, encoding information in the audio output 129 may also help to prevent the electronic device 100 from being illegitimately paired (e.g., by malicious software at the electronic device 100) with a malicious device, such as an electronic device 133 having a microphone 134 and a decoder 137 (e.g., a third-party device that is associated with a third-party application at the electronic device 100, which may attempt to use the audio pairing capabilities of the electronic device 100 to covertly pair with the malicious electronic device 133 so that the malicious electronic device 133 can execute code 139 for extracting information from the paired electronic device 100). For example, if the malicious device were not prevented from (e.g., covertly) pairing with the electronic device 100 by the secure audio pairing technology described herein, the malicious device may be able to access one or more input components, such as microphones and/or cameras, location information, contact information, and/or other personal and/or private information stored at the electronic device 100.

Although three openings 108, an opening 111, and an opening 118 are shown in FIG. 1, this is merely illustrative. One opening 108, two openings 108, or more than two openings 108 may be provided on any of various surfaces of the housing 106 for one speaker 114, two speakers 114, or more than two speakers 114. One opening 111, two openings 111, or more than two openings 111 may be provided on any of various surfaces of the housing 106 for one microphone 115, two microphones 115, or more than two microphones 115. In the example of FIG. 1, a single opening 118 is provided for a single camera 119. However, this is merely illustrative. One opening 118, two openings 118, or more than two openings 118 may be provided on any of various surfaces of the housing 106 for one camera 119, two cameras 119, or more than two cameras 119.

In some implementations, one or more groups of openings in housing 106 and/or groups of openings may be aligned with a single port of an input component within housing 106. Housing 106, which may sometimes be referred to as a case, an enclosure, or a frame, may be formed of plastic, glass, ceramics, fiber composites, metal (e.g., stainless steel, aluminum, etc.), other suitable materials, or a combination of any two or more of these materials.

In one or more implementations, two or more speakers 114 may be operable to spatialize an audio output 129 of the electronic device 100 to be perceived, by a user or wearer of the electronic device 100, as originating from a location remote from the speakers 114 and/or the electronic device 100 (e.g., including perceived locations within the head of the user and/or perceived locations in the external environment of the electronic device outside the head of the user and remote from the electronic device 100).

The configuration of electronic device 100 of FIG. 1 is merely illustrative. In other implementations, electronic device 100 may be a computer such as a computer that is integrated into a display such as a computer monitor, a laptop computer, a media player, a gaming device, a navigation device, a computer monitor, a television, a headphone, an earbud, a smartphone, a tablet, or other electronic equipment having at least one speaker and one or more input components. As discussed herein, in some implementations, electronic device 100 may be provided in the form of a wearable device such as a smart watch, a head mountable device, or smart glasses. In one or more implementations, housing 106 may include one or more interfaces for mechanically coupling housing 106 to one or more structures 123 (e.g., straps, arms, or other attachment mechanisms) that are configured for securing housing 106 to a wearer (e.g., to a wrist or a head of the wearer). In one or more implementations, one or more cameras, such as camera 119, of the electronic device 100 may face in a direction of a field of view of a user of the electronic device 100 when the electronic device 100 is worn by the user (e.g., to facilitate recording of video and/or capturing images corresponding approximately to what the user is viewing).

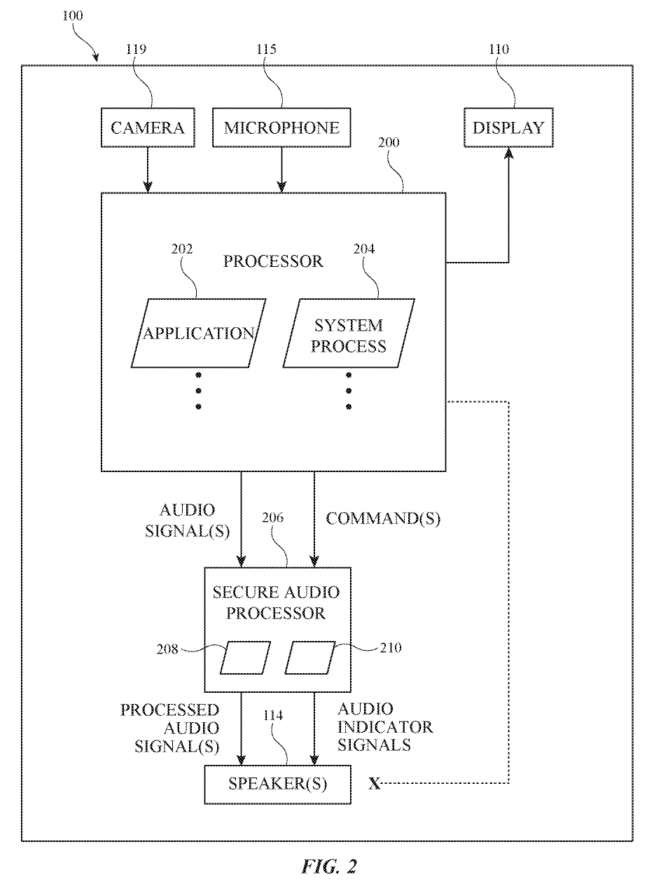

FIG. 2 illustrates an example architecture that may be implemented by an electronic device in accordance with one or more implementations of the subject technology. For explanatory purposes, portions of the architecture of FIG. 2 are described as being implemented by the electronic device 100 of FIG. 1, such as by one or more processors and/or memory of the electronic device; however, appropriate portions of the architecture may be implemented by any other wearable electronic device. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

Various portions of the architecture of FIG. 2 can be implemented in software, firmware, and/or hardware, including by one or more processors and a memory device containing instructions, which when executed by the processor cause the processor to perform the operations described herein. For example, in FIG. 2, the rectangular boxes may indicate that the camera 119, the microphone(s) 115, the display 110, the processor 200, the secure audio processor 206, and the speaker(s) 114 may be hardware components, and the trapezoidal boxes may indicate that the application(s) 202, the system process(es) 204, the processing blocks 208, and the secure audio generator 210 may be implemented in software, including by execution of instructions by one or more processors and a memory device containing the instructions, which when executed by the processor cause the processor to perform the operations described herein.

In the example of FIG. 2, the electronic device 100 includes first circuitry, such as processor 200, and second circuitry, such as secure audio processor 206. As shown, the secure audio processor 206 may provide audio signals to the speaker(s) 114, for output of corresponding audio content by the speaker(s) 114. As shown in FIG. 2, the processor 200 may be securely isolated from the speaker(s) 114. For example, the electronic device 100 may be provided without any direct communications path from the processor 200 to the speaker(s) 114 (e.g., without any communications path that does not pass through the secure audio processor 206). In this way, a secure audio processor 206 may be provided that can securely control all audio output from some or all of the speaker(s) 114. In various implementations, the processor 200 and the secure audio processor 206 may be implemented in separate physical processing architectures (e.g., on separate substrates, or as physically separate portions of a single substrate). In one or more other implementations, the secure audio processor 206 may be implemented in software, such as by implementing the secure audio processor as a containerized processing environment that is executable by the processor 200 without being modifiable by the processor 200.

As shown, the processor 200 may run (e.g., execute instructions for) one or more processes, such as one or more applications 202 and/or one or more system processes 204. For example, system process 204 may be a process that is controlled by an operating system of the electronic device 100. Application(s) 202 and/or system process(es) 204 may generate various audio signals for output by the speaker(s) 114 that is/are securely isolated from the processor 200 on which those processes run. As examples, applications 202 may generate audio signals corresponding to audio content for media (e.g., music, podcasts, audio books, audio tracks for video content and/or gaming applications), application sounds (e.g., bell sounds, button sounds, click sounds, alert sounds, notification sounds), and/or various other audio content. System process(es) 204 may generate audio signals corresponding to system sounds, such as bell sounds, button sounds, click sounds, alert sounds, notification sounds, and/or various other audio content. As shown in FIG. 2, the secure audio processor 206 and the speaker(s) 114 may be securely isolated from the application(s) 202 and the system process(es) 204 (e.g., the application(s) 202 and the system process(es) 204 may not have access to the secure audio processor 206 or be able to directly control the speaker(s) 114).

As shown, audio signals generated at the processor 200 (e.g., by the application(s) 202 and/or the system process(es) 204) may be provided to the secure audio processor 206 (e.g., rather than directly to the speaker(s) 114). The secure audio processor 206 may include one or more processing blocks 208 that process the audio signals received from the processor 200. As examples, the processing blocks 208 may apply one or more filters, noise reduction processes, volume adjustments, reverberation adjustments, spatialization operations, masking operations, distortion operations, detection operations, monitoring operations, speaker protection operations, and/or other audio signal processing operations to the received audio signals, and provide resulting processed audio signals to the speaker(s) 114 for output.

As one example, the secure audio processor 206 (e.g., the processing block(s) 208) may remove (e.g., using a high-pass filter, low-pass filter, or band-pass filter) audio content at one or more frequencies and/or in one or more frequency ranges, from the audio signals received from the processor 200. For example, the secure audio processor 206 (e.g., the processing block(s) 208) may remove low-frequency audio content, such as audio content having frequencies near or below a cutoff frequency (e.g., a cutoff frequency at or near the low end of a human audible range, such as at or near 20 Hz, or at or near 100 Hz). For example, the processing block(s) 208 may remove low-frequency sub-sonic content that is inaudible to a human ear. Removing audio content at certain frequencies, before the processed audio signals are provided to the speaker(s) 114 for output, can serve any of multiple purposes. These purposes can include speaker protection (e.g., preventing output of audio content that would operate the speaker(s) 114 outside of an approved or safe operating range for the speaker itself), speaker efficiency (e.g., preventing unnecessary power draw and thermal effects at the speaker(s) 114), and/or audio security (e.g., preventing output of unauthorized audio content by the speaker(s) 114)). In one or more implementations, the secure audio processor 206 may process the audio signals received from the processor 200 to remove audio content in a frequency range (e.g., the low-frequency range) that is reserved for audio indicators that the microphone(s) 115 and/or camera(s) 119 are in use. In one or more implementations, the secure audio processor 206 may process the audio signals received from the processor 200 to detect an attempt to output unauthorized encoded content (e.g., a passcode) in an audio output 129 from the speaker(s) 114, and modify the audio signals (e.g., by suppressing time and frequency localized areas of the signal, adding to the signal to change how the encoded information could be interpreted, non- linear modification of the signal such as modifying high and low portions of signal samples differently, and/or timing changes such as shifting in time or phase distortions, as discussed herein) to prevent a successful output of the unauthorized encoded content.

As shown in FIG. 2, the secure audio processor 206 may also include a secure audio generator 210. For example, the secure audio generator 210 may generate an audio signal for output of an audio indicator by the speaker(s) 114 responsive to a detection, by the processor 200, of a change in usage of the microphone(s) 115 and/or camera(s) 119. As another example, the secure audio generator 210 may generate an audio signal for output of encoded content, such as a passcode for pairing with another device (e.g., the electronic device 131 of FIG. 1). In one or more implementations, the secure audio generator 210 may be hard coded in the secure audio processor. In one or more other implementations, the secure audio generator 210 may be implemented in software that is stored in secure memory of the secure audio processor 206 (e.g., memory that is inaccessible to the processor 200).

The processor 200 (e.g., the system process 204 running on the processor 200) may be configured to monitor the operating states of the microphone(s) 115 and/or camera(s) 119 at the electronic device 100. As examples, the operating states of the microphone(s) 115 and/or camera(s) 119 may include an activated or in-use state, an inactivated or off state, a secure in-use state (e.g., in use by a secure process at the electronic device) or an insecure in-use state (e.g., in use by an insecure process at the electronic device). As examples, insecure processes at an electronic device may include processes associated with third-party applications (e.g., applications provided by a developer other than the provider of the operating system of the electronic device), and/or any (e.g., first-party or third party) processes that store input data (e.g., from the microphone(s) 115 and/or camera(s) 119) at the electronic device 100 and/or that transmit the input data off device (e.g., to another, remote device).

In one or more implementations, one or more secure processes at the electronic device 100 may be able to obtain input data from the microphone(s) 115 and/or camera(s) 119 without providing an audio indicator. For example, a secure process at the electronic device 100 may be a process for which explicit permission has been received from the user of the electronic device 100 to obtain input data and which does not store or transmit the input data. For example, a voice assistant application at the electronic device 100 may have explicit user permission to obtain microphone signals from one or more microphones 115 and to provide the microphone signals to a local machine learning model at the electronic device 100, the local machine learning model having been trained to recognize a trigger phrase the microphone signals. In one or more implementations, once the trigger phrase has been detected, the electronic device 100 may output an audio indicator that the microphone(s) 115 are entering use by an insecure process, and may then capture additional microphone signals and transmit the microphone signals, or an encoded version thereof, to a server for recognition of subsequent voice input(s). The electronic device 100 may then output another audio indicator once the recording of the subsequent voice input(s) is complete, to indicate that the microphone(s) 115 are no longer being used to capture data that is transmitted off device.

As another example, a computer vision application at the electronic device 100 may have explicit user permission to obtain image data from one or more cameras 119, and provide the image data to a local computer vision model at the electronic device 100, the local computer vision model having been trained to recognize one or more predetermined objects (e.g., physical objects in the physical world, such as cars, bicycles, product logos, signs, or the like) in image data. In one or more implementations, the electronic device 100 may generate audio or visual augmentation data for output to the user of the electronic device 100 when the predetermined object(s) are detected, without storing or transmitting the image data off device.

When the processor 200 determines that the operational state of some or all of the microphone(s) 115 and/or camera(s) 119 has changed (e.g., the microphone(s) 115 and/or camera(s) 119 have been activated, deactivated, accessed by an insecure process, or released by an insecure process), the processor 200 may, responsively, provide a command to the secure audio processor 206 to generate an audio indication of the corresponding change in operational state of the microphone(s) 115 and/or camera(s) 119. For example, the processor 200 may provide a first command to the secure audio processor 206 to generate a first audio indicator when the microphone(s) 115 and/or camera(s) 119 are activated or begin use by an insecure process, and provide a second command to the secure audio processor 206 to generate a second audio indicator when the microphone(s) 115 and/or camera(s) 119 are deactivated or released by the insecure process.

Responsive to receiving the first command from the processor 200, the secure audio generator 210 may generate an audio signal (e.g., an audio indicator signal) that includes audio content for the first audio indicator that the microphone(s) 115 and/or camera(s) 119 are in use and/or are in use by an insecure process at the electronic device 100. Responsive to receiving the second command from the processor 200, the secure audio generator 210 may generate an audio signal (e.g., an audio indicator signal) that includes audio content for the second audio indicator that the microphone(s) 115 and/or camera(s) 119 are no longer in use and/or are no longer in use by an insecure process at the electronic device 100.

Because the secure audio processor 206 processes all of the audio that is output by the speaker(s) 114, and can therefore remove any spoofed versions of the audio indicator signal(s), only the audio indicator signals generated by the secure audio generator 210 can be output by the speaker 114. In this way, the electronic device 100 is configured to be able to provide secure audio indicators (e.g., secure audio notifications) of the state (or a change in state) of the input component(s) of the electronic device.

In one or more implementations, the electronic device 100 may include multiple speakers 114, and may be able to spatialize the audio signals, prior to output by the speakers 114. In this way, the electronic device 100 may generate audio outputs to be perceived, by a user or wearer of the electronic device 100, as originating from any of various three-dimensional spatial locations around the electronic device 100, including locations away from (e.g., spatially separated from) the speakers 114 themselves. In one or more implementations, the secure audio processor 206 may process the audio signal(s) received from the processor 200 by spatializing those audio signal(s) to be perceived at a first location (e.g., within the user's head), and may spatialize the audio indicator signal(s) generated by the secure audio generator 210 to be perceived at a second location (e.g., outside the user's head and remote from the speaker(s) 114) different from the first location. In this way, the electronic device 100 may use the spatial distribution of the audio outputs to differentiate securely generated audio notifications of the state (or a change in state) of the input component(s) of the electronic device from other audio outputs (e.g., application and/or system generated sounds, generated at the processor 200) from the electronic device 100.

In one or more implementations, a user of the electronic device 100 may desire to pair the electronic device 100 with another electronic device, such as the electronic device 131 of FIG. 1. When a request to pair the electronic device 100 with the electronic device 131 is received (e.g., at the processor 200), the processor 200 may, responsively, provide a command to the secure audio processor 206 to generate a secure audio pairing output that includes encoded information (e.g., an encoded passcode, credential, or authorization information, or pairing information).

Responsive to receiving the command from the processor 200, the secure audio generator 210 may generate an audio signal (e.g., a secure audio pairing signal) that includes the encoded content. In one or more implementations, the secure audio processor 206 (e.g., the secure audio generator 210) may include additional content in the secure audio pairing signal, including, as examples, media content (e.g., music or a melody) that is configured to make the overall audio output 129 including the encoded content sound pleasant to a user, and/or audio- formatting content, such as one or more confirmation pulses, start pulses (e.g., configured to indicate a start of the encoded content the audio signal), one or more end pulses (e.g., configured to indicate an end of the encoded content the audio signal), and/or one or more synchronization pulses (e.g., configured to allow the electronic device 131 to synchronize a timing of the encoded content).

In some implementations, the secure audio generator 210 adapts the encoded content based on the presence and form of the additional content (e.g. a music sequence of notes that are arranged to be pleasing to the user). For example, the secure audio generator 210 may generate an audio waveform for the encoded passcode with timing and/or frequency content matches and/or complements that additional content. In one example in which the additional content has an underlying musical timing of notes, the timing of the added passcode waveforms may be synchronized to such notes. In one example in which the additional content has an underlying musical timing of notes that are different on a musical scale, the added passcode waveforms themselves may be generated to take on a music note characteristic that depends on (e.g., that is the same as and/or complementary to, and may therefore be that is pleasant to hear together with) the notes of the additional content.

In one or more implementations, in a use case in which the processor 200 (e.g., an application 200, such as a third-party application, which may be a malicious application, executing on the processor 200) generates a spoofed secure audio pairing signal for output by the speaker(s) 114, the secure audio processor 206 (e.g., the processing block(s) 208) may modify at least a portion of the spoofed secure audio processing signal to prevent the encoded content (e.g., and/or audio-formatting content) from being successfully included in the audio output from the speaker(s) 114.

Because the secure audio processor 206 processes all of the audio that is output by the speaker(s) 114, and can therefore remove any spoofed versions of the secure audio pairing signal, only the audio pairing signals generated by the secure audio generator 210 can be output by the speaker 114. In this way, the electronic device 100 is configured to be able to provide secure audio pairing for the electronic device.

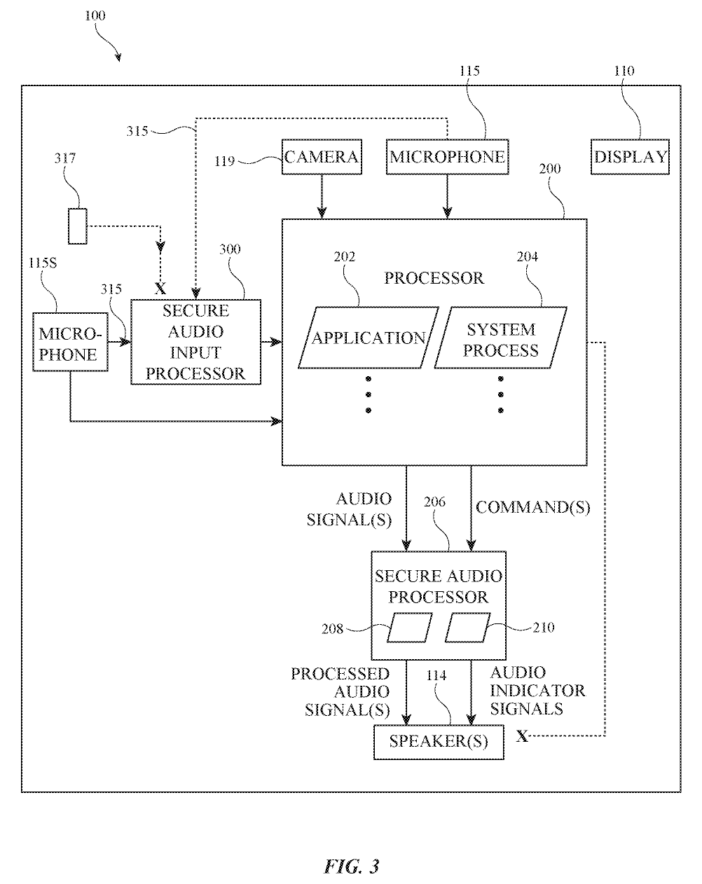

In the example of FIG. 2, the secure audio processor 206 is used to output secure audio indicators and/or secure encoded content using the speakers 114. In one or more implementations, the electronic device 100 may also, or alternatively, use secure microphone circuitry at the electronic device to confirm an output, by the speaker(s) 114, of an audio indicator signal relating to the microphone(s) 115 and/or camera(s) 119. For example, FIG. 3 illustrates an implementation in which the electronic device 100 includes a secure audio input processor 300 that receives a microphone signal from a microphone 115S. In this example, the microphone 115S is a secure microphone, as the microphone 115S is communicatively coupled to the secure audio input processor 300 (e.g., via a secure, direct hardware communication path 315), and the electronic device 100 does not include any communication path from any unsecure (e.g., non-microphone) audio source (e.g., a source 317, such as an artificial audio data generator, which may be executed by malware or other malicious processes, including processes executing on the processor 200) into the secure audio input processor 300. For example, the audio inputs to the secure audio input processor 300 may be hard coded conductive pathways (e.g., conductive traces in a silicon substrate) between the microphone(s) 115 and the secure audio input processor 300. In various implementations, one or a subset of the microphones 115 of the electronic device 100 may be secure microphones that have secure (e.g., non-tamperable, secure, direct hardware) communications paths to the secure audio input processor 300, or all of the microphones 115 of the electronic device 100 may be secure microphones that have secure (e.g., non-tamperable, secure, direct hardware) communications paths to the secure audio input processor 300. Although a secure microphone 115S is shown in FIG. 3, in one or more other implementations, another secure transducer, such as a secure inertial measurement unit (IM) or subcomponent (e.g., accelerometer) thereof, one or more standalone accelerometers, and/or features and/or components of the speaker(s) 114 themselves (e.g., using a secure current/voltage (IV) sensing operation, such as by sensing the current and/or voltage of the speaker during an expected output time of an audio indicator, and comparing the sensed current and/or voltage to a previously stored/measured current and/or voltage of the speaker during output of the audio indicator) may be used in place of, or in addition to, the secure microphone 115S for verification of output of an audio indicator. As shown, in some implementations, microphone signals from a secure microphone 115S may be provided to other processes and/or components of the electronic device 100 (e.g., including the processor 200), however, the inputs to secure audio input processor 300 may be secure (e.g., sources, components, and/or processors other than the microphone(s) 115 may be prevented from providing audio input data to the secure audio input processor 300).

In one or more implementations, the processor 200 may notify the secure audio input processor 300 of an expected output time of an audio indicator relating to the input component(s) of the electronic device. The secure audio input processor 300 may obtain microphone signals from the microphone 115S during the expected output time, and determine, using the microphone signals, whether the audio indicator was output by the speaker(s) 114 during the expected output time (e.g., by determining whether the microphone signals include a representation of the audio indicator). In various implementations, the secure audio input processor 300 may determine whether the audio indicator was output by the speaker(s) 114 during the expected output time by comparing the microphone signals to previously stored reference microphone signals corresponding to the audio indicator, and/or by providing the microphone signals to a machine learning model at the electronic device that has been trained to detect the audio indicator in microphone signals. In this way, whether the audio indicator was generated by the processor 200 (e.g., in implementations in which no secure audio processor is provided or available) or by the secure audio processor 206, the electronic device 100 can verify whether an intended audio indicator was output by the speaker(s) 114 at the expected output time.

In one or more implementations, the secure audio input processor 300 may also use the microphone signals from the microphone(s) 115S to listen for audio indicator sounds at times other than the expected output time of an audio notification (e.g., at all times during which the electronic device is powered on and/or at all times during which the microphones and/or cameras of the electronic device are in use). For example, the secure audio input processor 300 may be configured to detect an audio indicator that one or more input components of the electronic device 100 are no longer in use (or no longer in use by an insecure process) when, in fact, the one or more input components are still in use (e.g., by the insecure process). In this way, the electronic device 100 can detect spoofed audio indicators being output (e.g., in implementations in which the secure audio processor 206 is not provided or available to remove such spoofed audio indicators before they are output by the speaker(s) 114).

In one or more implementations, the secure audio input processor 300 may use multiple secure microphones 115S (and/or other secure transducers) to verify whether a spatialized audio indictor was output at the correct (e.g., secure) spatial location. For example, the secure audio input processor 300 may obtain a microphone signal corresponding to a left channel output (e.g., using a first microphone near a left speaker of the electronic device 100), obtain a microphone signal corresponding to a right channel output (e.g., using a second microphone near a right speaker of the electronic device 100), and compare the left channel output and the right channel output to determine the spatial location of an audio output from the left and right speakers. In the example discussed herein in which secure audio indicators are output to be perceived within the user's head (e.g., using mono audio output), the secure audio input processor 300 may compare the left channel output with the right channel output to determine whether the left channel output is the same as the right channel output (e.g., mono output).

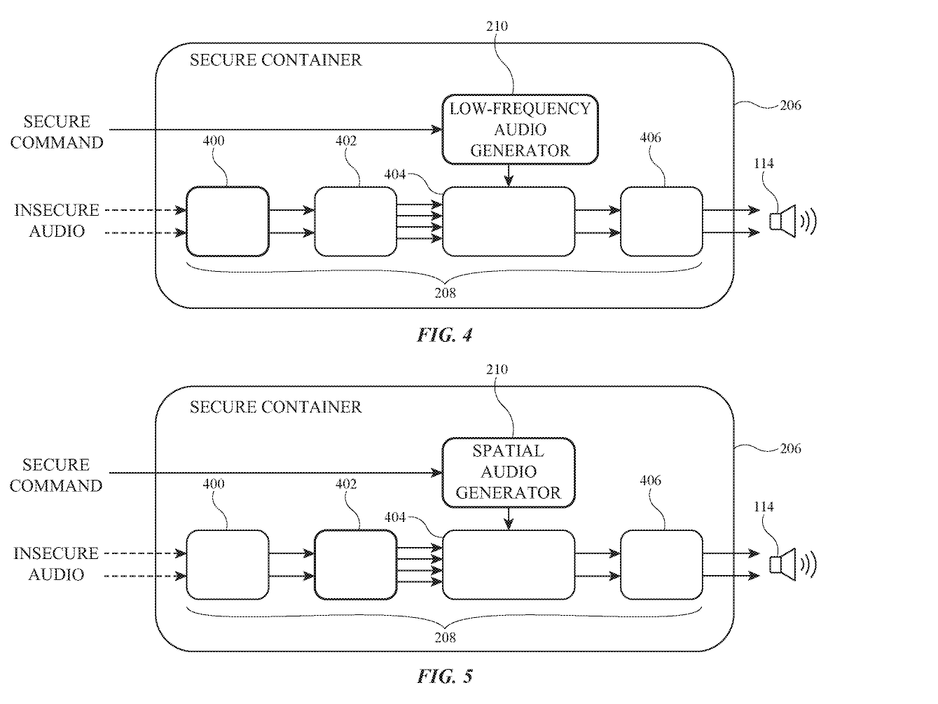

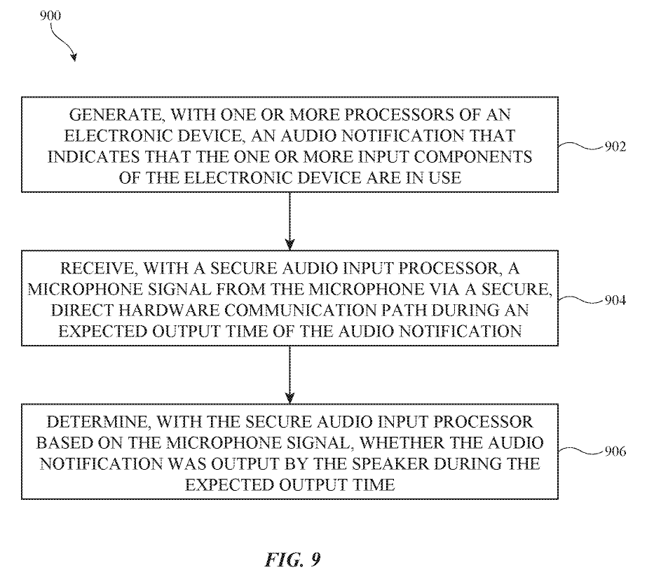

As discussed herein, the secure audio processor 206 may be configured to provide secure audio indicators (e.g., secure audio notifications) of the state (or a change in state) of the input component(s) of the electronic device, and/or securely include encoded (e.g., pairing) information in the audio output of the speaker 114. FIGS. 4-9 illustrate additional details relating to providing secure audio indicators (e.g., secure audio notifications) of the state (or a change in state) of the input component(s) of an electronic device. FIGS. 10-14 illustrate additional details relating to securely including encoded pairing information in the audio output of a speaker.

FIG. 4 is a block diagram illustrating an example implementation of the secure audio processor 206. As shown in FIG. 4, the processing blocks 208 that are executed by the secure audio processor 206 may include a filter 400 (e.g., a high pass filter), a spatial processor 402 (e.g., configured to spatialize audio signals for spatial output by the speaker(s) 114), a mixer 404 (e.g., a binaural mixer), and a speaker protection block 406 in some implementations. In the example of FIG. 4, a secure command (e.g., from the processor 200) may be received by the secure audio processor 206 and provided to the secure audio generator 210. In this example, the secure audio generator 210 may be a low-frequency (e.g., subsonic) audio generator that generates audio indicator signals a low frequencies, such as subsonic frequencies that are inaudible to the human ear or near the low end of the human audible frequency range. In one or more implementations, the secure audio generator 210 may generate audio indicators that include both an audible portion (e.g., a chime) and a sub-sonic or other very low frequency portion. For example, the audio indicator may include a chime that has audible components (e.g., at frequencies greater than 100 Hz), and includes (e.g., a burst of) very low frequency components (e.g., in the frequency range of 20-100Hz and/or sub-sonic components with frequencies less than 20 Hz). In this example, the (e.g., burst of) low frequency content moves the speaker diaphragm and, while the user/wearer may not hear the resulting low-frequency audio output, the low-frequency audio output may be felt as tactility. In the arrangements of FIGS. 2, 3 and 4, no incoming audio from outside the secure domain (e.g., generated outside the secure audio processor 206) would be capable of creating such a tactile sensation using the speaker(s) 114. In one or more implementations, the speaker(s) 114 that output the low frequency and/or sub-sonic audio content may be standard speakers (e.g., having a diaphragm that is actuated responsive to a current in a voice coil that is mounted in proximity to one or more magnets). In one or more other implementations, the speaker(s) 114 that output the low frequency and/or sub-sonic audio content may include features (e.g., an acoustically-driven mechanical resonator and/or a multi- degree-of-freedom transducer with a suspended motor) for enhancing the tactility of the low- frequency and/or sub-sonic output.

As shown, insecure audio signals (e.g., audio signal generated at and/or received from the processor 200) may also be received at the secure audio processor 206 and provided to the filter 400. The filter 400 may remove (e.g., filter out) predetermined portions of the insecure audio signals. For example, the filter 400 may be a high pass filter that removes low-frequency audio content from the insecure audio signals. In one or more use cases, this filtering by the filter 400 may remove a spoofed low-frequency audio indicator generated at the processor 200. In this example, the filter 400 and the secure audio generator 210 may be complementary processing blocks that, in combination, help to ensure that the only low-frequency outputs from the speaker(s) 114 are secure audio indicators generated by the secure audio processor 206. In one or more implementations, the filter 400 and/or one or more other processes of the secure audio processor 206 may also be used to modify portions of an audio signal that has been determined to include spoofed audio pairing information, as discussed in further detail hereinafter (e.g., in connection with FIGS. 10-14). In the example of FIG. 4, filtered audio signals may be provided to the spatial processor 402 for spatialization.

As shown, the spatialized and filtered audio signals, and the audio indicator signals generated by the secure audio generator 210, may both be provided to the mixer 404. The mixer 404 may combine the spatialized and filtered audio signals and the audio indicator signals generated by the secure audio generator 210 into one or more combined audio signals (e.g., a left combined audio signal for output by a left speaker and a right combined audio signal for output by a right speaker) for output. In the example of FIG. 4, the speaker protection block 406 may process the combined audio signal, and make one or more modifications to the combine audio signal(s) to protect the speaker(s) 114 from potential damage (e.g., due to operation of the speaker(s) outside of predetermined operating ranges) that would occur from output of the combined audio signal. As shown, the combined audio signals, processed by the speaker protection block 406 may then be provided to the speaker(s) 114 for output by the speaker(s) 114 (e.g., as sound and/or vibrations generated by the speaker(s) 114).

The example of FIG. 4 shows an implementation of the secure audio processor 206 in which the audio indicator is output at a frequency that is different from other audio that is output by the speaker(s) 114 (e.g., including a sub-sonic audio indicator). Sub-sonic audio indicators may cause the speaker(s) 114 to generate vibrations that can be felt by the user/wearer of the electronic device 100, rather than being heard by the user/wearer. In addition to the security benefits described herein, this type of sub-sonic indicator output by a speaker can be helpful, for example, for blind, deaf, and/or hearing impaired users/wearers. However, other types of audio indicators may be provided by the electronic device 100. For example, as discussed herein, in one or more implementations, the secure audio processor 206 may be configured to spatialize the audio indicators as part of the secure output of the audio indicators.

FIG. 5 illustrates an example implementation of the secure audio processor 206 for spatialization the audio indicators as part of the secure output of the audio indicators. In the example of FIG. 5, the secure audio generator 210 is implemented as spatial audio generator. For example, the secure audio generator 210 may be a reserved-location spatial audio generator configured to generate spatialized audio signals for an audio indicator that, when output by the speakers 114 of the electronic device 100, are perceived (e.g., by the user or wearer of the electronic device) as originating from a (e.g., predetermined) three-dimensional location (e.g., a secure location) that is reserved for the audio indicator(s) relating to the input component(s) of the electronic device 100. In this example, the spatial processor 402 may be unable to spatialize the filtered audio signals from the filter 400 to that reserved (e.g., secure) location. For example, the spatial processor 402 may force all insecure audio to be spatialized to non-secure locations (e.g., locations that are not reserved for the audio indicators generated by the secure audio generator 210). In this way, the audio indicators that are output by the speaker(s) 114 may be perceived by the user or wearer at a particular location that is different from the location at which other sounds generated by the device are perceived.

FIG. 6 illustrates an example in which the secure audio processor 206 of FIGS. 4 or 5 is provided together with a secure audio input processor 300 (e.g., and a secure microphone 115S, as discussed herein). As shown, in one or more implementations, the command that is provided from the processor 200 to the secure audio generator 210 may also be provided, from the secure audio processor 206, to a secure observer operation 600 of the secure audio input processor 300. In this way, the secure observer operation 600 can be securely informed (e.g., via the command received from the secure audio processor 206) of any expected output times during which the speaker(s) 114 are expected to output an audio indicator. In this way, the secure observer operation 600 can confirm whether expected audio indicators are output during expected output times (e.g., by comparing microphone signals from the secure microphone 115S to previously stored reference microphone signals corresponding to the audio indicator, and/or by providing the microphone signals to a machine learning model that has been trained to detect the audio indicator(s) in microphone signals), and/or detect unauthorized or spoofed audio indicators being output at other times (e.g., by detecting a microphone signal that includes a representation of one or more audio indicators when no audio indicator is expected).

In the example of FIG. 6, the secure audio processor 206 is provided in combination with the secure audio input processor 300. In one or more other implementations, the secure audio processor 206 can be provided without providing a secure audio input processor 300 (e.g., as in the examples of FIGS. 4 and 5), or the secure audio input processor 300 may be provided without providing a secure audio processor (e.g., and relying on the operations of the secure audio input processor 300 to provide the security for the audio indicators, by way of confirmation and spoof detection). In implementations such as the implementation of FIG. 6, in which the secure audio processor 206 is provided in combination with the secure audio input processor 300, the secure audio input processor 300 may provide further validation of the secure audio indicators, from a second secure compartment or container (e.g., that is communicatively isolated from the secure audio processor 206). For example, the secure microphone 115S and the secure audio input processor 300 may also be able to verify that the speaker hardware itself has not been hacked.

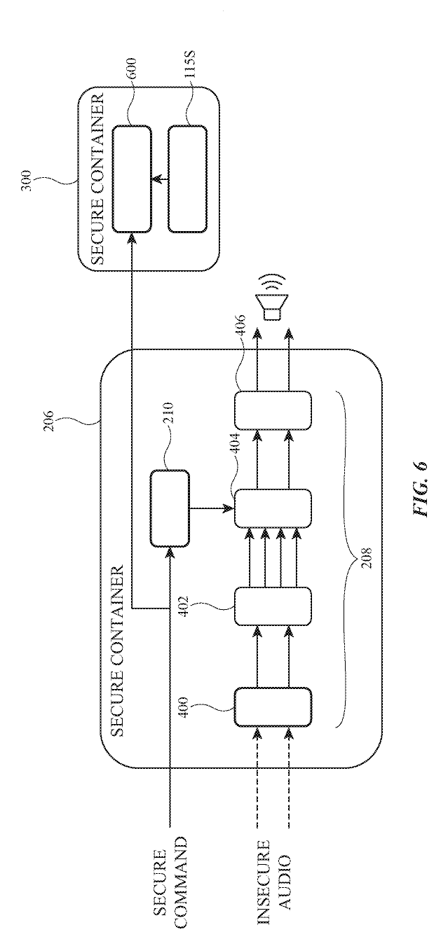

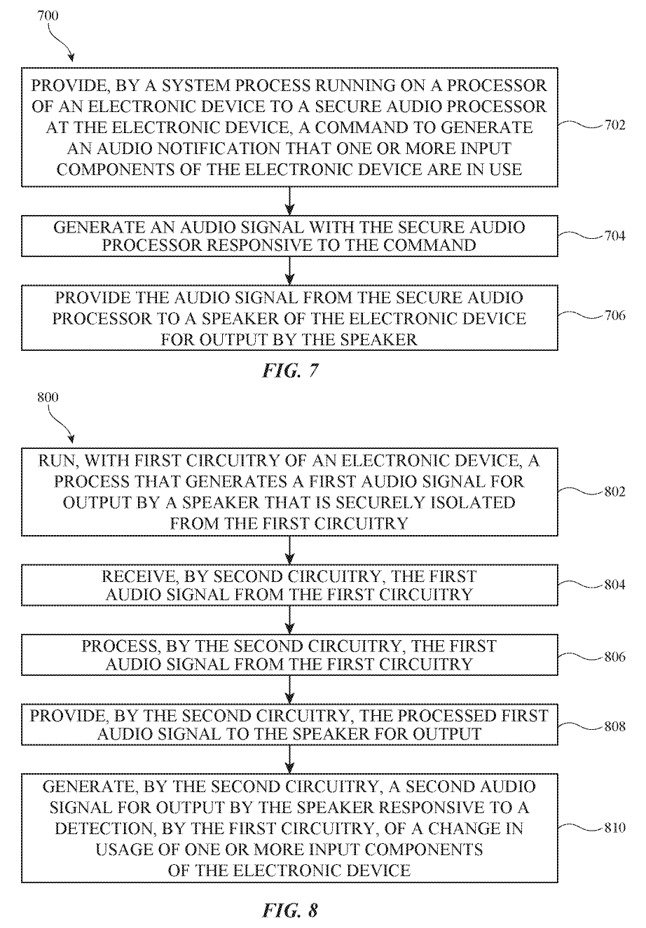

FIG. 7 illustrates a flow diagram of an example process for providing a secure audio indicator, in accordance with one or more implementations. For explanatory purposes, the process 700 is primarily described herein with reference to the electronic device 100 and the speaker(s) 114 of FIGS. 1 and 2. However, the process 700 is not limited to the electronic device 100 and the speaker(s) 114 of FIGS. 1 and 2, and one or more blocks (or operations) of the process 700 may be performed by one or more other components and other suitable devices. Further for explanatory purposes, the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

In the example of FIG. 7, at block 702, a system process (e.g., system process 204) running on a processor (e.g., processor 200) of an electronic device (e.g., electronic device 100) may provide, to a secure audio processor (e.g., secure audio processor 206) at the electronic device, a command to generate an audio notification (e.g., an audio indicator) that one or more input components (e.g., one or more microphones and/or cameras) of the electronic device are in use. In one or more implementations, providing the command may include providing the command responsive to a determination, by the system process, that the one or more input components of the electronic device are in use by an insecure process at the electronic device. For example, the insecure process may store and/or export information obtained by the one or more input components.

At block 704, the secure audio processor may generate an audio signal responsive to the command. In one or more implementations, generating the audio signal with the secure audio processor may include generating low-frequency audio content for output by the speaker. For example, the low-frequency audio content may be audio content having a frequency that is near or below the threshold for human audibility (e.g., near or below 20 Hz or near or below 100 Hz). In one or more implementations, the secure audio processor may also receive, from the processor, another audio signal (e.g., an insecure audio signal) that includes additional low- frequency audio content; remove the additional low-frequency audio content from the other audio signal; and provide the audio signal with the low-frequency audio content and the other audio signal having had the additional low-frequency audio content removed to the speaker for concurrent output by the speaker. In this way, the secure audio processor may prevent a spoofed version of the low-frequency audio content in the audio signal from being output by the speaker. In this way, the secure audio processor may allow audio generated by application(s) 202 and/or system process(es) 204 to be output from the speaker(s) 114, while preventing those application(s) 202 and/or system process(es) 204 from including a spoofed version of an audio indicator that gets output by the speaker.

In one or more implementations, generating the audio signal with the secure audio processor may include spatializing the audio signal to be perceived, upon output by the speaker and another speaker, at a particular spatial location relative to a user of the electronic device. In one or more implementations, the secure audio processor may also receive, from the processor, another audio signal; spatialize the other audio signal to be perceived, upon output by the speaker and the other speaker, at one or more locations other than the particular spatial location of the audio signal; and provide the spatialized audio signal and the spatialized other audio signal to the speaker for concurrent output by the speaker. As an example, the particular spatial location may be within a head of the user. For example, the secure audio generator 210 may generate a mono audio version of the audio indicator that, when output by the speaker(s) 114 is perceived, by the user of the electronic device 100 as originating from inside the user's head. In one or more implementations, the secure audio processor 206 (e.g., the spatial processor 402) may prevent any other audio from being output to that location (e.g., from being output as mono audio).

At block 706, the audio signal may be provided from the secure audio processor to a speaker (e.g., to one or more of the speakers 114) of the electronic device for output by the speaker. For example, the processor may be prevented from providing audio signals directly to the speaker. For example, the electronic device may be free of any communication pathways between the processor and the speaker that do not pass through the secure audio processor. For example, there may be no conductive traces, wires, or other physical communicative connections directly from the processor 200 to the speaker 114.

In one or more implementations, the process 700 may also include obtaining a microphone signal with a microphone (e.g., secure microphone 115S) of the electronic device during an expected output time of the output of the audio signal by the speaker; and confirming, by the processor using the microphone signal, that the audio signal was output by the speaker during the expected output time.

FIG. 8 illustrates a flow diagram of another example process 800 for providing a secure audio indicator, in accordance with one or more implementations. For explanatory purposes, the process 800 is primarily described herein with reference to the electronic device 100 and the speaker(s) 114 of FIGS. 1 and 2. However, the process 800 is not limited to the electronic device 100 and the speaker 114(s) of FIGS. 1 and 2, and one or more blocks (or operations) of the process 800 may be performed by one or more other components and other suitable devices. Further for explanatory purposes, the blocks of the process 800 are described herein as occurring in serial, or linearly. However, multiple blocks of the process 800 may occur in parallel. In addition, the blocks of the process 800 need not be performed in the order shown and/or one or more blocks of the process 800 need not be performed and/or can be replaced by other operations.

In the example of FIG. 8, at block 802, first circuitry (e.g., processor 200) of an electronic device (e.g., electronic device 100) may run a process (e.g., application 202 and/or system process 204) that generates a first audio signal for output by a speaker (e.g., speaker 114) that is securely isolated from the first circuitry.

At block 804, second circuitry (e.g., secure audio processor 206) of the electronic device may receive the first audio signal from the first circuitry. For example, the second circuitry may receive the first audio signal from the first circuitry over a communications path (e.g., a conductive trace on a substrate and/or in a flex circuit or wire) from the first circuitry to the second circuitry.

At block 806, the second circuitry (e.g., processing blocks 208) may process the first audio signal from the first circuitry. For example, the second circuitry may process the first audio signal by removing (e.g., using a filter 400) first low-frequency content from the first audio signal. As another example, the second circuitry may process the first audio signal by spatializing (e.g. using spatial processor 402) the first audio signal to be perceived at a first location (e.g., a first location relative to a user or wearer of the electronic device).

At block 808, the second circuitry may provide the processed first audio signal to the speaker for output. The speaker may then output first audio content according to the first audio signal. The second circuitry and the speaker may be securely isolated from the process.

At block 810, the second circuitry may generate a second audio signal for output by the speaker responsive to a detection, by the first circuitry, of a change in usage of one or more input components (e.g., microphone(s) 115 and/or camera(s) 119) of the electronic device. For example, the second circuitry may generate the second audio signal responsive to a command from the first circuitry. In one or more implementations, the change in usage of the one or more input components may include initiating usage of the one or more input components by an insecure process at the electronic device. In one or more implementations, the change in usage may include a termination of the usage of the one or more input components by the insecure process at the electronic device.

In one or more implementations (e.g., including implementations in which the second circuitry processes the first audio signal by removing first low-frequency content from the first audio signal), the second audio signal may include second low-frequency audio content generated by the second circuitry. For example, the second low-frequency audio content may include sub-sonic content that is inaudible to a human ear. In one or more implementations, the first low-frequency audio content that is removed from the first audio signal may include other sub-sonic content that is inaudible to the human ear. In one or more use cases, the first low- frequency audio content that is removed from the first audio signal may include a spoofed version, generated by the first circuitry, of the second low-frequency audio content generated by the second circuitry.

In one or more implementations (e.g., including implementations in which the second circuitry processes the first audio signal by spatializing the first audio signal to be perceived at a first location), the second circuitry may also spatialize the second audio signal to be perceived at a second location different from the first location (e.g., a location outside the user's head, such as a location that is remote from the speaker(s) that output the second audio signal).

In one or more implementations, the process 800 may also include confirming, with secure microphone circuitry (e.g., a secure microphone 115S or other secure transducer, and secure audio input processor 300), an output, by the speaker, corresponding to the second audio signal (e.g., at or during an expected output time for the second audio signal).

FIG. 9 illustrates a flow diagram of an example process for confirming output of an audio indicator, in accordance with one or more implementations. For explanatory purposes, the process 900 is primarily described herein with reference to the electronic device 100 and the speaker(s) 114 of FIGS. 1 and 2. However, the process 900 is not limited to the electronic device 100 and the speaker 114(s) of FIGS. 1 and 2, and one or more blocks (or operations) of the process 900 may be performed by one or more other components and other suitable devices. Further for explanatory purposes, the blocks of the process 900 are described herein as occurring in serial, or linearly. However, multiple blocks of the process 900 may occur in parallel. In addition, the blocks of the process 900 need not be performed in the order shown and/or one or more blocks of the process 900 need not be performed and/or can be replaced by other operations.

In the example of FIG. 9, at block 902, one or more processors (e.g., processor 200 and/or secure audio processor 206) of an electronic device (e.g., electronic device 100) may generate an audio notification (e.g., an audio indicator) that indicates that one or more input components (e.g., one or more microphones 115 and/or cameras 119) of the electronic device are in use (e.g., by an insecure process at the electronic device).

At block 904, a secure audio input processor (e.g., secure audio input processor 300) may receive a microphone signal from a microphone (e.g., microphone 115S) via a secure, direct hardware communication path between the microphone and the secure audio input processor during an expected output time of the audio notification. In one or more implementations, the one or more input components include at least one other microphone (e.g., another microphone 115) having a communication path to the one or more processors. In one or more implementations, the one or more input components include a camera (e.g., camera 119). In one or more implementations, the one or more input components may include the microphone.

At block 906, the secure audio input processor may determine, based on the microphone signal, whether the audio notification was output by a speaker of the electronic device during the expected output time. In one or more implementations, the one or more processors may terminate operation of the one or more input components responsive to a determination, by the secure audio input processor, that the audio notification was not output by the speaker during the expected output time.

In one or more implementations, the one or more processors include a first processor (e.g., processor 200) that is securely isolated from the speaker and that is configured to run an application (e.g., application 202) that generates an audio signal for output by the speaker, and a second processor (e.g., secure audio processor 206) configured to: receive the audio signal from the first processor and provide at least a version (e.g., a processed version, processed by the processing blocks 208) of the audio signal to the speaker for output; and generate another audio signal corresponding to the audio notification for output by the speaker during the expected output time.

In one or more implementations, the process 900 may also include, with the secure audio input processor, receiving another microphone signal from the microphone while the one or more input components are in use (e.g., at a time other than the expected output time of the audio notification); determining, based on the other microphone signal, that another notification (e.g., another audio indicator) that indicates that the one or more input components are no longer in use has been output by the speaker; and providing, to the one or more processors, a signal that indicates that a spoofed audio notification has been output by the speaker. In one or more implementations, the one or more processors may terminate operation of the one or more input components and/or provide an alert responsive to a determination, by the secure audio input processor, that the spoofed audio notification has been output by the speaker.

FIG. 10 is a block diagram illustrating an example implementation of the secure audio processor 206 in a configuration for preventing spoofed secure audio pairing outputs. As shown in FIG. 10, the processing blocks (e.g., implementations of the processing blocks 208 of FIG. 2) that are executed by the secure audio processor 206 may include a masking block 1000, a detector 1002, and the mixer 404 described in connection with FIG. 4. In this example, the filter 400, the spatial processor 402, and the speaker protection block 406 are omitted. However, it is appreciated that the masking block 1000 and the detector 1002 can be implemented together with the filter 400, the spatial processor 402, and/or the speaker protection block 406 (e.g., in implementations in which the secure audio processor is configured for both providing secure audio indicators and secure audio pairing). For example, the masking block 1000 may be switchably coupled, before or after the filter 400, into the signal processing pathway of the secure audio processor of FIGS. 4, 5 and/or 6, (e.g., responsive to a control signal generated by the detector 1002 when a spoofed audio indicator is detected by the detector), and bypassed when no spoofed audio indicator is detected by the detector 1002.

In the example of FIG. 10, the secure audio generator 210 may generate an audio signal that includes encoded content, such as an encoded passcode, credential, authorization information, or pairing information. For example, in a normal operating scenario, such as a use case in which a user desires to pair the electronic device 100 with another device, such as the electronic device 131, the secure audio generator 210 may generate the audio signal with valid encoded information, and provide the audio signal with the valid encoded information to the speaker(s) 114 for output. The valid encoded information may include one or more encoded bits corresponding to the passcode, credential, authorization information, pairing information, or the like, and/or audio-formatting information. For example, the audio-formatting information may include one or more pulses or other audio features that indicate a start of the encoded information (e.g., one or more trigger pulses configured to trigger a detector at the other device to begin a decoding operation), an end of the encoded information, and/or synchronization information. For example, one or more start pulses and/or one or more end pulses may be configured to trigger a decoder (e.g., decoder 135 of FIG. 1) at the other device (e.g., the pairing target device) to decode the encoded bits in the audio output from the speaker 114, and execute pairing operations using the decoded bits. One or more synchronization pulses may also be used by the decoder at the other device for synchronizing a timing of the encoded bits.

As discussed herein, a secondary signal may be included with the signals that carry the passcode and audio-formatting information, for example a musical melody which is designed to be pleasing to the user. In such cases the signals generated to carry the passcode and audio- formatting may additionally be matched to the secondary signal. Matching may include timing such signals to match events, e.g. notes, in the secondary signal, and/or generating waveforms which are themselves pleasing when played synchronously with the secondary signal, e.g. passcodes may be sequences of notes which musically match and/or are complementary to those of a musical secondary signal. In such cases, the "Passcode Playback" generated by the secure audio generator 210, which may include a passcode and formatting signal generation operations, may take in the secondary signal itself to establish timing, e.g. detect notes, and introduce the secondary signal back into the passcode playback appropriately synchronized with the passcode and formatting signals.

As shown, the secure audio processor 206 may also be configured to prevent a non- secure audio source 1004 outside the secure audio processor 206 (e.g., an application 202, which may be malware or a third-party application, running on the processor 200) from successfully outputting an audio signal including spoofed encoded information. For example, if the non- secure audio source 1004 attempts to output audio with an encoded passcode, the secure audio processor 206 (e.g., the masking block 1000) may modify the one or more portions of the audio signal before the entire encoded passcode sequence can be successfully output by the speaker(s) 114.

For example, as shown, an audio signal 1006 (e.g., a non-secure audio signal) from the processor 200 may be provided to both the masking block 1000 and the detector 1002 (e.g., to determine, by the detector 1002, if content in the signal could be interpreted by a decoder as a passcode). For example, the detector 1002 may mimic at least a portion of the decoder (e.g., decoder 135) of a receiving device for encoded information from the secure audio generator 210.

When the audio signal 1006 includes spoofed encoding information (e.g., a spoofed audio pairing signal, which may include one or more bits of information encoded into the audio signal), the detector 1002 may detect a first portion (e.g., in time) of the audio signal 1004 that indicates that encoded information (e.g., encoded bits) is about to be emitted. For example, the first portion of the audio signal 1006 may include audio-formatting information, such as start pulse that indicates a start of encoded information in the audio signal 1006.

When the audio-formatting information is detected by the detector 1002, the detector 1002 may cause the masking block 1000 to modify at least part of a second portion of the audio signal 1006 before the second portion of the non-secure audio signal is emitted by the speaker(s) 114. When no audio-formatting information is detected by the detector 1002, the detector 1002 may cause the masking block to be turned off, or bypassed, to allow the audio signal 1006 to pass through to the speaker(s) 114 (e.g., after passing through the filter 400, the spatialization processor 402, the mixer 404 and/or the speaker protection block 406 in some implementations).

In one or more implementations, the detector 1002 may detect the audio-formatting information in the audio signal 1006 while (e.g., in parallel with) the first portion of the audio signal 1006 is being output by the speaker(s) 114. For example, when the audio-formatting information is detected by the detector 1002, the detector 1002 may cause the masking block 1000 to modify one or more subsequent (e.g., in time) portions of the audio-formatting and/or encoded information in the audio signal 1006. By modifying only a later portion of an audio signal while an earlier portion of the audio signal is being output by the speaker in this way, the detector 1002 can destroy or obfuscate enough of the information in a spoofed encoded audio signal to prevent successful operations on the encoded information therein at a remote device, without having to delay (e.g., to attempt to detect and/or modify/block entire encoded sequences) legitimate audio outputs from the processor 200.

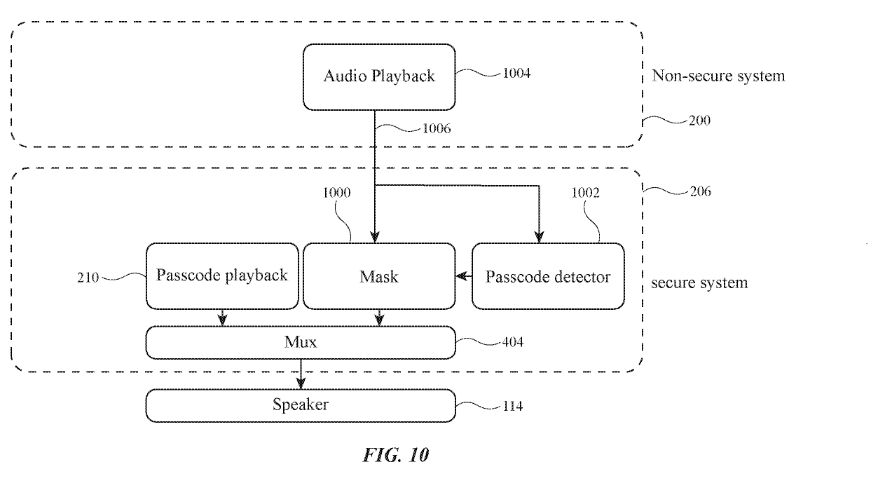

For example, FIG. 11A illustrates a spectrogram 1100 of audio-formatting information in the form of an audio pulse 1104 that may be output by the speaker(s) 114. FIG. 11A also shows a spectrogram 1102 of a modified version 1004M of the audio pulse 1104, after modification by the masking block 1000. In various examples, the masking block 1000 may apply various modifications to the audio pulse 1104. As examples, the masking block 1000 may be implemented as a filter function, a scaling function, an adding function, a time-shifting function, a muting function, or a combination of one or more of these and/or other audio processing functions. For example, the filter function may be a linear filter function (e.g., a notch filter, a bandpass filter, a bandstop filter, a combination of these filters, or the like), or a non-linear filter that masks bit-representations of samples (e.g., Float32 -> Intl6 -> Float32, or mantissa or exponent bit manipulation). For example, a scaling function may scale down or non- linearly modify a portion of an audio signal. For example, an adding function may add additional content to an audio signal. In one or more implementations, the modification may include a combination of a filter function, a scaling function, and an adding function (e.g., by notching out a portion of an audio signal, scaling or non-linearly modifying the notched out portion, and then adding the scaled portion back to the notched signal). For example, a time- shifting function may time-shift one or more portions of an audio signal so that that portion of the audio signal may still be present in the audio signa, but not at the time at which a decoder expects that portion of the audio signal (e.g., by applying all-pass phase modifying filters with large group delays in intended bands). In one or more implementations, the modification may be configured to avoid contravening subsequent limits on the audio output of the speaker (e.g., to avoid generating modified audio signals that would have portions cutoff by a subsequent speaker protection block 406, which could cause unpleasantly distorted sounds to be emitted by the speaker).

In order, for example, to prevent a more sophisticated attacker from anticipating the modification to be applied by the masking block 1000 and pre-distorting the spoofed audio signal so that the modification applied by the masking block 1000 actually restores the intended encoded information, the modification applied by the masking block 1000 may be different at different times. For example, the modification applied at any given time may be one of multiple predetermined modifications that is (e.g., randomly) selected by the secure audio processor (e.g., by the detector or the masking block). In this way, an attacker can be prevented from anticipating the modification to their spoofed output.

In one or more implementations, the audio pulse 1104 that is modified by the masking block 1000 may be an end pulse or a confirmation pulse at or near the end of the portion of the audio signal 1006 that includes encoded information, as shown in the wider-views of the spectrograms 1100 and 1102 in FIG. 11B.

For example, as shown in FIG. 11B, the audio signal with the encoded information may include an audio pulse 1105 (e.g., configured as a start pulse or trigger pulse that, when received by a decoder of another device, such as via a microphone of the other device, causes the decoder to look for and decode one or more encoded bits in the incoming audio stream) in a first portion, P1, of the audio signal. As shown, the audio signal may include, in a second portion, P2, thereof, encoded bits 1106 (e.g., bit pulses), and other audio content 1108. For example, the other audio content 1108 may include media content (e.g., music, podcast content, or other media content) and/or synchronization content (e.g., one or more synchronization pulses that can be used by a receiving device to synchronize the audio signal content for a decoder. As shown, in one or more implementations, different portions of an audio signal with encoded content (e.g., a legitimate audio signal with encoded content, or a spoofed audio signal mimicking a legitimate audio signal) may include different portions in different frequency bands.

In the example of FIG. 11B, different portions of the audio signal containing the audio content are included in different frequency bands. For example, the audio pulses 1105 and 1104 may be emitted in a first frequency band, F1, the encoded bits may be emitted in a second frequency band, F2, lower than the first frequency band, F1, and the additional audio content 1108 may be emitted in a third frequency band, F3, lower than the second frequency band. Although the frequency band, F2, is lower than the frequency band, F1, and the frequency band, F3, is lower than the frequency band, F3 in this example, this is merely illustrative and the audio pulses 1105 and 1104, the encoded bits 1106, and the audio content 1108 can be distributed in other frequency space arrangements (e.g., the audio pulses 1105 and 1104 can be emitted in a frequency range that is higher than, lower than, overlapping with, or offset from the frequency range(s) in which the encoded bits 1106 and/or and the audio content 1108 are emitted, and/or the encoded bits 1106 may be emitted in a frequency range that is higher than, lower than, overlapping with, or offset from the frequency range(s) in which the audio content 1108 is emitted). In some examples, the audio pulses 1105 and 1104, the encoded bits 1106, and the audio content 1108 can be emitted in the same frequency range.

In the example of FIG. 11B, the audio pulse 1104 is modified by the masking block 1000. In this example, a decoder at another device can receive the audio pulse 1105, the encoded bits 1106, and the other audio content 1108, but be prevented from processing the encoded bits 1106 by preventing the audio pulse 1104 (e.g., a confirmation pulse) from being detected by the other device. However, this is merely illustrative and, as discussed in connection with FIG. 10, other modifications may be made, including modifications to the encoded bits 1106 themselves, and/or to one or more synchronization pulses.

In the example of FIG. 11B, the audio pulses 1104 and 1105, the encoded bits 1106, and the other audio content 1108 appear the same in the spectrograms for simplicity of the current description. However, it is appreciated that the bit pulses 1106 may have time and/or frequency features that encode specific bits, and may be different from each other and/or from the audio-formatting pulses 1104 and 1105, and/or different from the other audio content 1108. Moreover, the audio pulses 1104 and 1105 may be different from each other, and the other audio content 1108 may include pulses (e.g., synchronization pulses) and audio content that is not in pulse form).

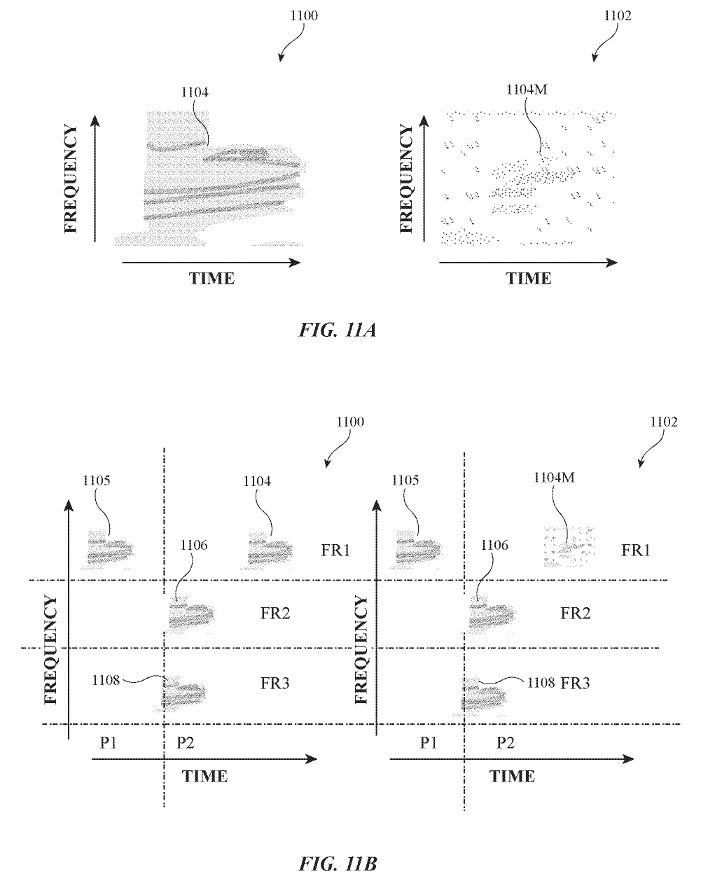

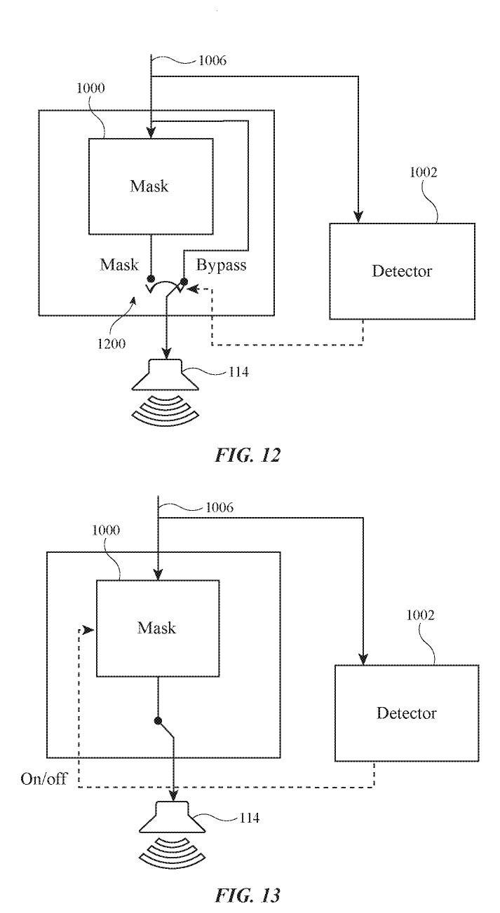

As discussed herein, the detector 1002 may be configured to control whether the masking block 1000 applies a modification to the audio signal 1006 received from the processor 200 based on whether an indicator of encoded content (e.g., audio-formatting information, such as an audio pulse 1105 configured as a start pulse) is detected in the audio signal, by causing the masking block to be bypassed or by enabling and disabling the masking block itself. For example, FIG. 12 illustrates an implementation in which the detector 1002 controls a switch 1200 (e.g., a software switch) that switches the output to the speaker 114 between a path that bypasses the masking block 1000 (e.g., when the audio pulse 1105 or another indicator of encoded content is not detected by the detector 1002) and a path that passes through the masking block 1000 (e.g., when the audio pulse 1105 or another indicator of encoded content is detected by the detector 1002). In this example, the masking block 1000 may be running even when the output of the masking block is not being used (e.g., not being provided to the speaker 114). FIG. 13 illustrates another implementation, in which the detector 1002 controls the masking block 1000 itself (e.g., by changing the filter coefficients or other parameters to turn on and off the masking operations of the masking block 1000).

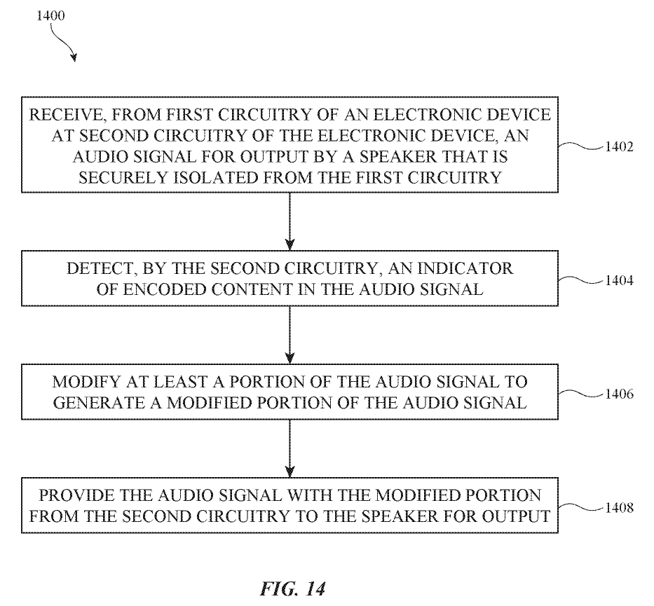

FIG. 14 illustrates a flow diagram of an example process for providing secure audio pairing, in accordance with one or more implementations. For explanatory purposes, the process 1400 is primarily described herein with reference to the electronic device 100 and the speaker(s) 114 of FIGS. 1, 2, 10, 12 and/or 13. However, the process 1400 is not limited to the electronic device 100 and the speaker 114(s) of FIGS. 1, 2, 10, 12 and /or 13, and one or more blocks (or operations) of the process 1400 may be performed by one or more other components and other suitable devices. Further for explanatory purposes, the blocks of the process 1400 are described herein as occurring in serial, or linearly. However, multiple blocks of the process 1400 may occur in parallel. In addition, the blocks of the process 1400 need not be performed in the order shown and/or one or more blocks of the process 1400 need not be performed and/or can be replaced by other operations.

In the example of FIG. 14, at block 1402, an audio signal (e.g., audio signal 1006) may be received from first circuitry (e.g., processor 200) of an electronic device (e.g., electronic device 100) at second circuitry (e.g., secure audio processor 206) of the electronic device, for output by a speaker (e.g., speaker 114) that is securely isolated from the first circuitry.

At block 1404, the second circuitry (e.g., the detector 1002 of the secure audio processor 206) may detect (e.g., in a first portion, such as portion P1 of FIG. 10, of the audio signal) an indicator (e.g., an audio pulse 1105, such as a start pulse, a trigger pulse, or a series or set of start and/or trigger pulser or sounds) of encoded content (e.g., encoded bits 1106) in (e.g., a second portion, such as a subsequent portion, P2, that follows the first portion in time, of) the audio signal. For example, the encoded content may include a passcode for pairing of the electronic device with another electronic device (e.g., the electronic device 131 or the electronic device 133 of FIG. 1).

At block 1406, responsive to the detecting, at least a portion (e.g., the second portion) of the audio signal may be modified (e.g., by the second circuitry, such as by masking block 1000 of the secure audio processor 206) to generate a modified portion (e.g., a modified second portion, such as modified second portion including a modified audio pulse 1104M) of the audio signal.

At block 1408, the audio signal including the modified portion (e.g., the first portion of the audio signal and the modified second portion of the audio signal) may be provided (e.g., by the second circuitry) to the speaker for output (e.g., from the speaker 114). For example, the audio signal including the modified portion to the speaker may include providing the first portion of the audio signal and the modified second portion of the audio signal to the speaker for output, which may include providing the first portion of the audio signal to the speaker for output while (e.g., in parallel with) detecting the indicator (e.g. of the upcoming encoded content) in the first portion of the audio signal.

In one or more implementations, detecting the indicator in (e.g., the first portion of) the audio signal at block 1404 may include detecting one or more pulses (e.g., an audio pulse 1105, such as a start pulse a trigger pulse, or a series or set of start and/or trigger pulses or sounds) in (e.g., the first portion of) the audio signal, that are configured to trigger a decoder (e.g., decoder 135 or decoder 137) at another electronic device (e.g., the electronic device 131 or the electronic device 133 of FIG. 1) to perform a decoding operation for decoding the encoded content. For example, the one or more pulses may include at least one pulse (e.g., a start pulse configured to indicate a start of the encoded content in the audio signal and/or a confirmation pulse) configured to indicate one or more of a start or a confirmation of the encoded content the audio signal. In another example, the one or more pulses also include one or more synchronization pulses (e.g., in the other audio content 1108) configured to allow the other device to synchronize a timing of the encoded content.

In one or more implementations, modifying at least the portion (e.g., the second portion) of the audio signal may include distorting a subsequent pulse (e.g., an end pulse or a subsequent confirmation pulse, such as audio pulse 1104), following the at least one pulse and in the (e.g., second portion of) audio signal, configured to indicate an end or a subsequent confirmation of the encoded content in the audio signal. In one or more implementations, modifying at least the portion (e.g., the second portion) of the audio signal to generate the modified (e.g., second) portion of the audio signal may include distorting at least some of the encoded content. For example, the encoded content may include a plurality of encoded bits (e.g., encoded bits 1106), and distorting at least some of the encoded content may include modifying (e.g., filtering, or otherwise modifying, as discussed in connection with FIG. 10) at least some of the plurality of encoded bits. In one or more implementations, modifying at least the portion (e.g., the second portion) of the audio signal may include modifying the (e.g., second) portion of the audio signal using a first modification operation selected substantially randomly from a plurality of modification operations.

In one or more implementations, the audio signal may include the indicator in a first frequency range (e.g., F1) of a first portion (e.g., P1) of the audio signal, the encoded content (e.g., encoded bits 1106) in a second frequency range (e.g., F2), different from (e.g., higher than, lower than, or offset from) the first frequency range, and distributed across the first portion (e.g., P1) and a second portion (e.g., P2) of the audio signal, and media content (e.g., additional audio content 1108) in a third frequency range (e.g., F3), different from (e.g., higher than, lower than, or offset from)the second frequency range, and distributed across the first portion and the second portion of the audio signal.

In one or more implementations, the audio signal may have been generated by an application (e.g., an audio playback source 1004, such as an application 202) running on the first circuitry of the electronic device and received by the second circuitry via an application programming interface (e.g., API 1890) of the electronic device. In one or more implementations, the other electronic device may be a wearable electronic device (e.g., electronic device 133) manufactured by a provider (e.g., a third-party provider) other than a provider of the electronic device, and the wearable electronic device include code (e.g., code 139) for extracting information (e.g., microphone signals, images, sensor signals, location information, stored data, etc.) from the electronic device following the pairing.

In the example of FIG. 14, the audio signal may be an illegitimate or spoofed audio signal from an untrusted or unsecure process at the electronic device. In one or more use cases, the electronic device may also generate (e.g., by secure audio generator 210) a legitimate secure audio pairing signal for output by the speaker. For example, the process 1400 may also include, by the second circuitry of the electronic device: generating a secure audio pairing signal that includes: a legitimate indicator (e.g., a legitimate pulse 1105, which may may be legitimate due to the knowledge and/or approval of the user and/or the operating system of the electronic device that the secure audio pairing signal is being generated) in a first frequency range (e.g., FR1) of a first portion (e.g., P1) of the secure audio pairing signal, legitimate encoded content (e.g., legitimate encoded bits 1106, which may may be legitimate due to the knowledge and/or approval of the user and/or the operating system of the electronic device that the secure audio pairing signal is being generated) in a second frequency range (e.g., FR2), different from (e.g., higher than, lower than, or offset from) the first frequency range, and distributed across the first portion and a second portion (e.g., P2) of the secure audio pairing signal, and legitimate media content (e.g., legitimate audio content 1108, which may may be legitimate due to the knowledge and/or approval of the user and/or the operating system of the electronic device that the secure audio pairing signal is being generated) in a third frequency range (e.g., FR3), different from (e.g., higher than, lower than, or offset from) the second frequency range, and distributed across the first portion and the second portion of the secure audio pairing signal; and providing, by the second circuitry, the secure audio pairing signal to the speaker for output.

In one or more implementations, generating the secure audio pairing signal may include generating the legitimate encoded content based at least in part on the legitimate media content (e.g., by generating an audio waveform for the legitimate encoded content with timing and/or frequency content that matches and/or complements the legitimate media content). For example, the second circuitry may receive or obtain one or more bits to be encoded in an audio signal, and generate the audio signal to encode the one or more bits based on timing and/or frequency features of the legitimate media content.

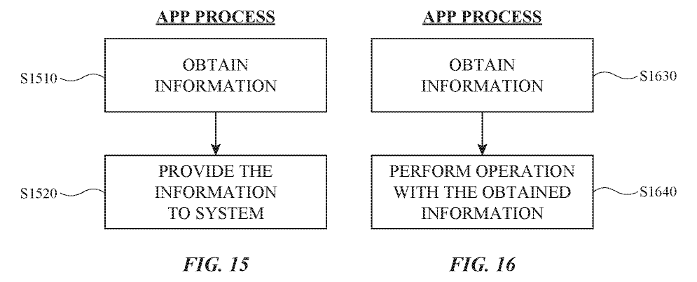

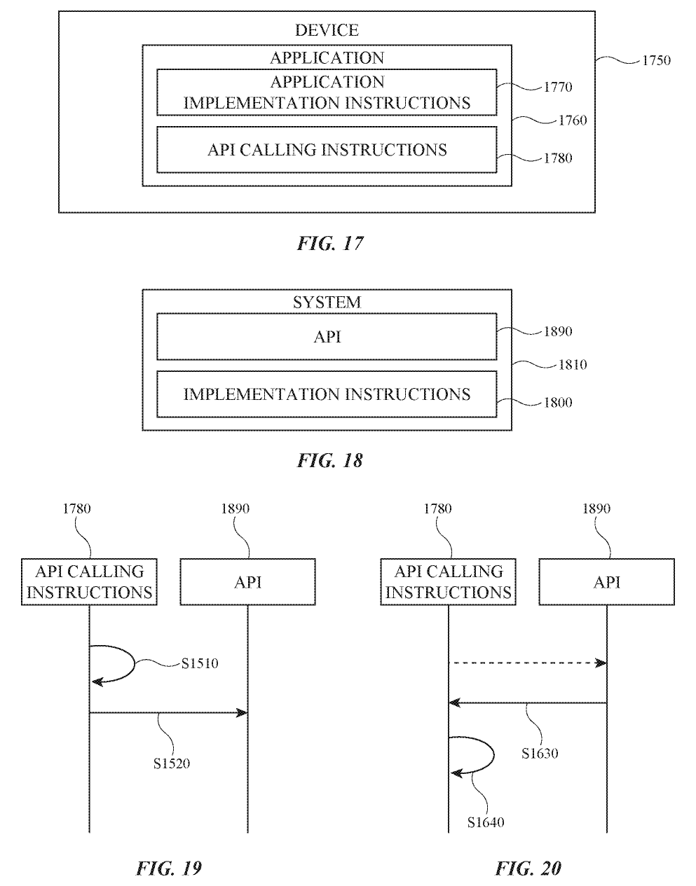

Implementations within the scope of the present disclosure include a computer-readable storage medium that encodes instructions organized as an application (e.g., application 1760 of FIG. 17) that, when executed by one or more processing units, control an electronic device (e.g., device 1750 of FIG. 17) to perform the method of FIGS. 7, 8, 9 and /or 14, the method of FIG. 15, the method of FIG. 16, and/or one or more other processes and/or methods described herein.

It should be recognized that application 1760 (shown in FIG. 17) can be any suitable type of application, including, for example, one or more of: a browser application, an application that functions as an execution environment for plug-ins, widgets or other applications, a fitness application, a health application, a digital payments application, a media application, a social network application, a pairing application, an assisted hearing application, a messaging application, and/or a maps application. In some embodiments, application 1760 is an application that is pre-installed on device 1750 at purchase (e.g., a first party application). In other embodiments, application 1760 is an application that is provided to device 1750 via an operating system update file (e.g., a first party application or a second party application). In some embodiments, application 1760 is an application that is provided via an application store. In some embodiments, the application store can be an application store that is pre-installed on device 1750 at purchase (e.g., a first party application store). In some embodiments, the application store is a third-party application store (e.g., an application store that is provided by another application store, downloaded via a network, and/or read from a storage device).

Referring to FIGS. 15 and 19, application 1760 obtains information (e.g., S1510). In some embodiments, at S1510, information is obtained from at least one hardware component of the device 1750. In some embodiments, at S1510, information is obtained from at least one software module (e.g., set of instructions) of the device 1750. In some embodiments, at S1510, information is obtained from at least one hardware component external to the device 1750 (e.g., a peripheral device, an accessory device, a paired device, and/or a server). In some embodiments, the information obtained at S1510 includes positional information, time information, image information, notification information, user information, environment information, electronic device state information, microphone signals, images, health information, weather information, media information, historical information, event information, hardware information, and/or motion information. In one or more implementations, the information obtained at S1510 may include an image captured by an external hardware component, and/or microphone signals captured by an external hardware component. In some embodiments, in response to and/or after obtaining the information at S1510, application 1760 provides the information to a system (e.g., S1520).

In some embodiments, the system (e.g., system 1810 shown in FIG. 18) is an operating system hosted on the device 1750. In some embodiments, the system (e.g., system 1810 shown in FIG. 18) is an external device (e.g., a server, a peripheral device, an accessory, a paired device and/or a personal computing device) that includes an operating system.

Referring to FIGS. 16 and 20, application 1760 obtains information (e.g., S1630). In some embodiments, the information obtained at S1630 includes positional information, time information, notification information, images, microphone signals, location information, user information, health information, environment information, electronic device state information, weather information, media information, historical information, event information, hardware information and/or motion information. In one or more implementations, the information obtained at S1630 may include images from one or more cameras, microphone signals from one or more microphones, motion information from one or more accelerometers, gyroscopes, magnetometers, and/or GPS components. In one or more implementations, the information obtained at S1630 may include information stored in memory of the device 1750. In one or more implementations, the information obtained at S1630 may be obtained in response to providing first information (e.g., encoded audio information) to an operating system (e.g., at S1520). In response to and/or after obtaining the information at S1630, application 1760 performs an operation with the information (e.g., S1640). In some embodiments, the operation performed at S1640 includes: providing a notification based on the information, sending a message based on the information, displaying the information, controlling a user interface based on the information, transmitting the information to a remote device or system, controlling a user interface based on the information, and/or calling an API of system 1810 based on the information. In one or more implementations, the operation performed at S1640 includes one or more of the operations described herein in connection with FIGS. 2-10, 12, 13 and/or 14.

In some embodiments, one or more steps of the method of FIG. 15 and/or the method of FIG. 16 is performed in response to a trigger. In some embodiments, the trigger includes detection of an event, a notification received from system 1810, a user input, and/or a response to a call to an API provided by system 1810.

In some embodiments, the instructions of application 1760, when executed, control device 1750 to perform the method of FIG. 15 and/or the method of FIG. 16 by calling an application programming interface (API) (e.g., API 1890) provided by system 1810. In some embodiments, application 1760 performs at least a portion of the method of FIG. 15 and/or the method of FIG. 16 without calling API 1890.

In some embodiments, one or more steps of the method of FIG. 15 and/or the method of FIG. 16 includes calling an API (e.g., API 1890) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 17, device 1750 is illustrated. In some embodiments, device 1750 is a personal computing device, a smart phone, a smart watch, a fitness tracker, a head mounted display (HMD) device, a media device, a communal device, a speaker, a television, and/or a tablet. Device 1750 includes application 1760 and an operating system (not shown) (e.g., system 1810 shown in FIG. 18). Application 1760 includes application implementation instructions 1770 and API-calling instructions 1780. System 1810 includes API 1890 and implementation instructions 1800. It should be recognized that device 1750, application 1760, and/or system 1810 can include more, fewer, and/or different components than illustrated in FIG. 17 and 18.

In some embodiments, application implementation instructions 1770 is a software module that includes a set of one or more computer-readable instructions. In some embodiments, the set of one or more instructions of instructions 1770 correspond to one or more operations performed by application 1760. For example, when application 1760 is a messaging application, application implementation instructions 1770 can include operations to receive and send messages. In some embodiments, application implementation instructions 1770 communicates with API calling instructions to communicate with system 1810 via API 1890 (shown in FIG. 18).

In some embodiments, API-calling instructions 1780 is a software module that includes a set of one or more computer-executable instructions.

In some embodiments, implementation instructions 1800 is a software module that includes a set of one or more computer-executable instructions.

In some embodiments, API 1890 is a software module that includes a set of one or more computer-executable instructions. In some embodiments, API 1890 provides an interface that allows a different set of instructions (e.g., API-calling instructions 1780) to access and/or use one or more functions, methods, procedures, data structures, classes, and/or other services provided by implementation instructions 1800 of system 1810. For example, API-calling instructions 1780 can access a feature of implementation instructions 1800 through one or more API calls or invocations (e.g., embodied by a function or a method call) exposed by API 1890 and can pass data and/or control information using one or more parameters via the API calls or invocations. In some embodiments, API 1890 allows application 1760 to use a service provided by a Software Development Kit (SDK) library. In some embodiments, application 1760 incorporates a call to a function or method provided by the SDK library and provided by API 1890 or uses data types or objects defined in the SDK library and provided by API 1890. In some embodiments, API- calling instructions 1780 makes an API call via API 1890 to access and use a feature of implementation instructions 1800 that is specified by API 1890. In such embodiments, implementation instructions 1800 can return a value via API 1890 to API-calling instructions 1780 in response to the API call. The value can report to application 1760 the capabilities or state of a hardware component of device 1750, including those related to aspects such as input capabilities and state, output capabilities and state, processing capability, power state, storage capacity and state, and/or communications capability. In some embodiments, API 1890 is implemented in part by firmware, microcode, or other low level logic that executes in part on the hardware component.

In some embodiments, API 1890 allows a developer of API-calling instructions 1780 (which can be a third-party developer) to leverage a feature provided by implementation instructions 1800. In such embodiments, there can be one or more set of API-calling instructions (e.g., including API-calling instructions 1780) that communicate with implementation instructions 1800. In some embodiments, API 1890 allows multiple sets of API-calling instructions written in different programming languages to communicate with implementation instructions 1800 (e.g., API 1890 can include features for translating calls and returns between implementation instructions 1800 and API-calling instructions 1780) while API 1890 is implemented in terms of a specific programming language. In some embodiments, API-calling

instructions 1780 calls APIs from different providers such as a set of APIs from an OS provider, another set of APIs from a plug-in provider, and/or another set of APIs from another provider (e.g., the provider of a software library) or creator of the another set of APIs.

Examples of API 1890 can include one or more of. a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 1750. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 1800 is a system (e.g., operating system, server system) software module (e.g., a collection of computer-readable instructions) that is constructed to perform an operation in response to receiving an API call via API 1890. In some embodiments, implementation instructions 1800 is constructed to provide an API response (via API 1890) as a result of processing an API call. By way of example, implementation instructions 1800 and API-calling instructions 1780 can each be any one of an operating system, a library, a device driver, an API, an application program, or other module. It should be understood that implementation instructions 1800 and API-calling instructions 1780 can be the same or different type of software module from each other. In some embodiments, implementation instructions 1800 is embodied at least in part in firmware, microcode, or other hardware logic.

In some embodiments, implementation instructions 1800 returns a value through API 1890 in response to an API call from API-calling instructions 1780. While API 1890 defines the syntax and result of an API call (e.g., how to invoke the API call and what the API call does), API 1890 might not reveal how implementation instructions 1800 accomplishes the function specified by the API call. Various API calls are transferred via the one or more application programming interfaces between API-calling instructions 1780 and implementation instructions 1800. Transferring the API calls can include issuing, initiating, invoking, calling, receiving, returning, and/or responding to the function calls or messages. In other words, transferring can describe actions by either of API-calling instructions 1780 or implementation instructions 1800. In some embodiments, a function call or other invocation of API 1890 sends and/or receives one or more parameters through a parameter list or other structure.

In some embodiments, implementation instructions 1800 provides more than one API, each providing a different view of or with different aspects of functionality implemented by implementation instructions 1800. For example, one API of implementation instructions 1800 can provide a first set of functions and can be exposed to third party developers, and another API of implementation instructions 1800 can be hidden (e.g., not exposed) and provide a subset of the first set of functions and also provide another set of functions, such as testing or debugging functions which are not in the first set of functions. In some embodiments, implementation instructions 1800 calls one or more other components via an underlying API and thus be both a set of API calling instructions and a set of implementation instructions. It should be recognized that implementation instructions 1800 can include additional functions, methods, classes, data structures, and/or other features that are not specified through API 1890 and are not available to API-calling instructions 1780. It should also be recognized that API-calling instructions 1780 can be on the same system as implementation instructions 1800 or can be located remotely and access implementation instructions 1800 using API 1890 over a network. In some embodiments, implementation instructions 1800, API 1890, and/or API-calling instructions 1780 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, a method 700, a method 800, a method 900, and/or a method 1400 is performed at a first computer system (as described herein) via a system process (e.g., an operating system process, a server system process) that is different from one or more applications executing and/or installed on the first computer system.

In some embodiments, a method 700, a method 800, a method 900, and/or a method 1400 is performed at a first computer system (as described herein) by an application that is different from a system process. In some embodiments, the instructions of the application, when executed, control the first computer system to perform a method 700, a method 800, a method 900, and/or a method 1400 by calling an application programming interface (API) provided by the system process. In some embodiments, the application performs at least a portion of a method 700, a method 800, a method 900, and/or a method 1400 without calling the API.

In some embodiments, the application can be any suitable type of application, including, for example, one or more of: a browser application, an application that functions as an execution environment for plug-ins, widgets or other applications, a pairing application, a fitness application, a health application, a digital payments application, a media application, a social network application, a camera application, a recording application, a chat application, a messaging application, and/or a maps application.

In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre- installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform a method 700, a method 800, a method 900, and/or a method 1400 by calling an application programming interface (API) provided by the system process using one or more parameters.

In some embodiments, at least one API is a software module (e.g., a collection of computer-readable instructions) that provides an interface that allows a different set of instructions (e.g., API calling instructions) to access and use one or more functions, methods, procedures, data structures, classes, and/or other services provided by a set of implementation instructions of the system process. The API can define one or more parameters that are passed between the API calling instructions and the implementation instructions.

As described above, in some embodiments, the application controls the first computer system to perform a method 700, a method 800, a method 900, and/or a method 1400 by calling an application programming interface (API) provided by the system process using one or more parameters.

In some embodiments, exemplary APIs provided by the system process include one or more of. a pairing API (e.g., for establishing secure connection, e.g., with an accessory), a device detection API (e.g., for locating nearby devices, e.g., media devices and/or smartphone), a payment API, a UIKit API (e.g., for generating user interfaces), a VisionKit API (e.g., for extracting text from an image), a location detection API, a locator API, a maps API, a health sensor API, a sensor API, a messaging API, a push notification API, a video conferencing API, an application store API, an advertising services API, a web browser API (e.g., WebKit API), a networking API, a WiFi API, a Bluetooth API, an NFC API, a UWB API, a fitness API, a smart home API, contact transfer API, a photos API, a camera API, a microphone API, and/or an image processing API.

In some embodiments, the API 1890 defines a first API call that can be provided by API-calling instructions 1780, wherein the definition for the first API call specifies the call parameters (e.g., an image and/or text extracted from the image).

In some embodiments, the API 1890 defines a first API call response that can be provided to the application by API-calling instructions 1780, wherein the first API call response includes one or more rankings of one or more menu items.

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call. In some embodiments, the set of implementation instructions is included in the device (e.g., 1750) that runs the application. In some embodiments, the set of implementation instructions is included in an electronic device that is separate from the device that runs the application.

As described above, one aspect of the present technology is the gathering and use of data available from specific and legitimate sources for providing user information in association with providing a secure audio indicator and/or securing audio pairing . The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for providing a secure audio indicator and/or securing audio pairing. Accordingly, use of such personal information data may facilitate transactions (e.g., on-line transactions). Further, other uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of providing a secure audio indicator and/or securing audio pairing, the present technology can be configured to allow users to select to "opt in" or "opt out" of participation in the collection of personal information data during registration for services or anytime thereafter. In addition to providing "opt in" and "opt out" options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

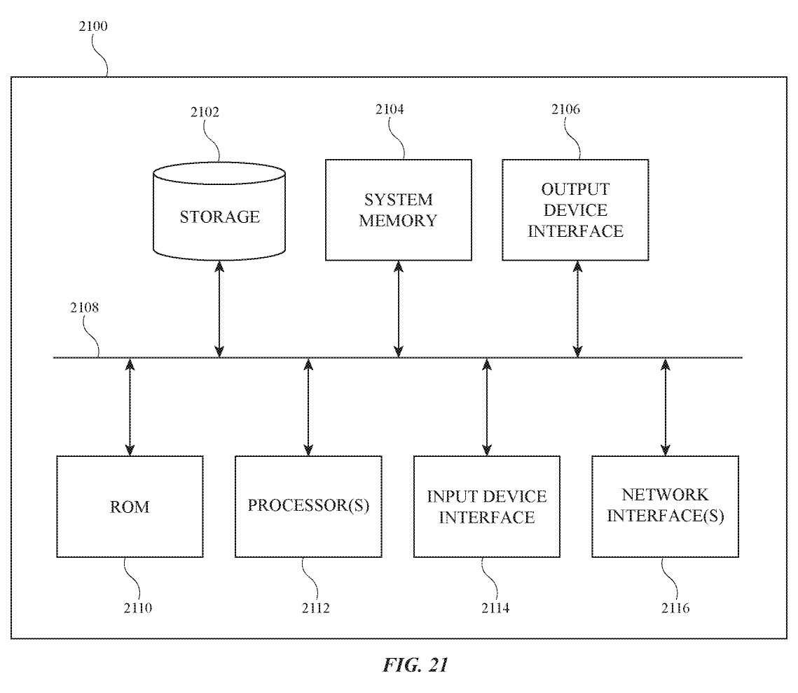

FIG. 21 illustrates an electronic system 2100 with which one or more implementations of the subject technology may be implemented. The electronic system 2100 can be, and/or can be a part of, one or more of the electronic device 100 shown in FIG. 1. The electronic system 2100 may include various types of computer readable media and interfaces for various other types of computer readable media. The electronic system 2100 includes a bus 2108, one or more processing unit(s) 2112, a system memory 2104 (and/or buffer), a ROM 2110, a permanent storage device 2102, an input device interface 2114, an output device interface 2106, and one or more network interfaces 2116, or subsets and variations thereof.

The bus 2108 collectively represents all system, peripheral, and chipset buses that communicatively connect the numerous internal devices of the electronic system 2100. In one or more implementations, the bus 2108 communicatively connects the one or more processing unit(s) 2112 with the ROM 2110, the system memory 2104, and the permanent storage device 2102. From these various memory units, the one or more processing unit(s) 2112 retrieves instructions to execute and data to process in order to execute the processes of the subject disclosure. The one or more processing unit(s) 2112 can be a single processor or a multi-core processor in different implementations.

The ROM 2110 stores static data and instructions that are needed by the one or more processing unit(s) 2112 and other modules of the electronic system 2100. The permanent storage device 2102, on the other hand, may be a read-and-write memory device. The permanent storage device 2102 may be a non-volatile memory unit that stores instructions and data even when the electronic system 2100 is off. In one or more implementations, a mass-storage device (such as a magnetic or optical disk and its corresponding disk drive) may be used as the permanent storage device 2102.

In one or more implementations, a removable storage device (such as a floppy disk, flash drive, and its corresponding disk drive) may be used as the permanent storage device 2102. Like the permanent storage device 2102, the system memory 2104 may be a read-and-write memory device. However, unlike the permanent storage device 2102, the system memory 2104 may be a volatile read-and-write memory, such as random access memory. The system memory 2104 may store any of the instructions and data that one or more processing unit(s) 2112 may need at runtime. In one or more implementations, the processes of the subject disclosure are stored in the system memory 2104, the permanent storage device 2102, and/or the ROM 2110. From these various memory units, the one or more processing unit(s) 2112 retrieves instructions to execute and data to process in order to execute the processes of one or more implementations.

The bus 2108 also connects to the input and output device interfaces 2114 and 2106. The input device interface 2114 enables a user to communicate information and select commands to the electronic system 2100. Input devices that may be used with the input device interface 2114 may include, for example, microphones, alphanumeric keyboards and pointing devices (also called "cursor control devices"). The output device interface 2106 may enable, for example, the display of images generated by electronic system 2100. Output devices that may be used with the output device interface 2106 may include, for example, printers and display devices, such as a liquid crystal display (LCD), a light emitting diode (LED) display, an organic light emitting diode (OLED) display, a flexible display, a flat panel display, a solid state display, a projector, a speaker or speaker module, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 21, the bus 2108 also couples the electronic system 2100 to one or more networks and/or to one or more network nodes through the one or more network interface(s) 2116. In this manner, the electronic system 2100 can be a part of a network of computers (such as a LAN, a wide area network ("WAN"), or an Intranet, or a network of networks, such as the Internet. Any or all components of the electronic system 2100 can be used in conjunction with the subject disclosure.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Various functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer- readable medium (alternatively referred to as computer-readable storage media, machine- readable media, or machine-readable storage media). Some examples of such computer-readable media include RAM, ROM, read-only compact discs (CD-ROM), recordable compact discs (CD- R), rewritable compact discs (CD-RW), read-only digital versatile discs (e.g., DVD-ROM, dual- layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms "computer", "processor", and "memory" all refer to electronic or other technological devices. These terms exclude people or groups of people. For the purposes of the specification, the terms "display" or "displaying" means displaying on an electronic device. As used in this specification and any claims of this application, the terms "computer readable medium" and "computer readable media" are entirely restricted to tangible, physical objects that store information in a form that is readable by a computer. These terms exclude any wireless signals, wired download signals, and any other ephemeral signals.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term "software" is meant to include firmware residing in read- only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Some of the blocks may be performed simultaneously. For example, in certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean "one and only one" unless specifically so stated, but rather "one or more." Unless specifically stated otherwise, the term "some" refers to one or more. Pronouns in the masculine (e.g., his) include the feminine and neuter gender (e.g., her and its) and vice versa. Headings and subheadings, if any, are used for convenience only and do not limit the subject disclosure.

The predicate words "configured to", "operable to", and "programmed to" do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an "aspect" does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a "configuration" does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word "example" is used herein to mean "serving as an example or illustration." Any aspect or design described herein as "example" is not necessarily to be construed as preferred or advantageous over other aspects or design.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase "means for" or, in the case of a method claim, the element is recited using the phrase "step for." Furthermore, to the extent that the term "include," "have," or the like is used in the description or the claims, such term is intended to be inclusive in a manner similar to the term "comprise" as "comprise" is interpreted when employed as a transitional word in a claim.

What is claimed is:

1. A method, comprising:
receiving, from first circuitry of an electronic device at second circuitry of the electronic device, an audio signal for output by a speaker that is securely isolated from the first circuitry;
detecting, by the second circuitry, an indicator of encoded content in the audio signal;
responsive to the detecting, modifying at least a portion of the audio signal to generate a modified portion of the audio signal; and
providing, by the second circuitry, the audio signal including the modified portion to the speaker for output.

2. The method of claim 1, wherein detecting the indicator comprises detecting the indicator in a first portion of the audio signal, wherein modifying at least the portion of the audio signal comprises modifying a second portion of the audio signal that follows the first portion of the audio signal, and wherein providing the audio signal including the modified portion to the speaker comprises providing the first portion and the modified second portion of the audio signal to the speaker for output.

3. The method of claim 2, wherein providing the first portion of the audio signal and the modified second portion of the audio signal to the speaker for output comprises providing the first portion of the audio signal to the speaker for output while detecting the indicator in the first portion of the audio signal.

4. The method of claim 1, wherein the encoded content comprises a passcode for pairing of the electronic device with an other electronic device.

5. The method of claim 4, wherein the audio signal has been generated by an application running on the first circuitry of the electronic device and received by the second circuitry via an application programming interface of the electronic device.

6. The method of claim 5, wherein the other electronic device comprises a wearable electronic device manufactured by a provider other than a provider of the electronic device, and wherein the wearable electronic device comprises code for extracting information from the electronic device following the pairing.

7. The method of claim 1, wherein detecting the indicator comprises detecting one or more pulses, in the audio signal, that are configured to trigger a decoder at an other electronic device to perform a decoding operation for decoding the encoded content.

8. The method of claim 7, wherein the one or more pulses comprise at least one pulse configured to indicate one or more of a start or a confirmation of the encoded content the audio signal.

9. The method of claim 8, wherein the one or more pulses further comprise one or more synchronization pulses configured to allow the other device to synchronize a timing of the encoded content.

10. The method of claim 8, wherein modifying at least the portion of the audio signal comprises distorting a subsequent pulse, following the at least one pulse in the audio signal, the subsequent pulse configured to indicate an end or a subsequent confirmation of the encoded content in the audio signal.

11. The method of claim 8, wherein modifying at least the portion of the audio signal comprises distorting at least some of the encoded content.

12. The method of claim 11, wherein the encoded content comprises a plurality of encoded bits, and wherein distorting at least some of the encoded content comprises modifying at least some of the plurality of encoded bits.

13. The method of claim 1, wherein modifying at least the portion of the audio signal comprises modifying at least the portion of the audio signal using a first modification operation selected substantially randomly from a plurality of modification operations.

14. The method of claim 1, wherein the audio signal comprises:
the indicator in a first frequency range of a first portion of the audio signal;
the encoded content in a second frequency range, different from the first frequency range, and distributed across the first portion and a second portion of the audio signal; and
media content in a third frequency range, different from the second frequency range, and distributed across the first portion and the second portion of the audio signal.

15. The method of claim 1, further comprising, by the second circuitry of the electronic device: generating a secure audio pairing signal that includes: a legitimate indicator in a first frequency range of a first portion of the secure audio pairing signal, legitimate encoded content in a second frequency range, different from the first frequency range, and distributed across the first portion and a second portion of the secure audio pairing signal, and legitimate media content in a third frequency range, different from the second frequency range, and distributed across the first portion and the second portion of the secure audio pairing signal; and providing, by the second circuitry, the secure audio pairing signal to the speaker for output.

16. The method of claim 15, wherein generating the secure audio pairing signal comprises generating the legitimate encoded content based at least in part on the legitimate media content.

17. An electronic device, comprising:
first circuitry configured to run a process that generates an audio signal for output by a speaker that is securely isolated from the first circuitry; and
second circuitry configured to:receive, from the first circuitry, the audio signal for output by the speaker that is securely isolated from the first circuitry;detect an indicator of encoded content in the audio signal;responsive to detection of the indicator, modify at least a portion of the audio signal to generate a modified portion of the audio signal; andprovide the audio signal including the modified portion to the speaker for output.

18. The electronic device of claim 17, wherein the second circuitry is configured to detect the indicator in a first portion of the audio signal, wherein the at least the portion of the audio signal comprises a second portion of the audio signal that follows the first portion of the audio signal, and wherein the second circuitry is configured to provide the audio signal including the modified portion to the speaker by providing the first portion and the modified second portion of the audio signal to the speaker for output.

19. The electronic device of claim 18, wherein the second circuitry is configured to provide the first portion of the audio signal to the speaker for output while detecting the indicator in the first portion of the audio signal.

20. A secure audio processor configured to:
receive, from another processor that is securely isolated from a speaker of an electronic device, an audio signal for output by the speaker that is securely isolated from the other processor;
detect an indicator of encoded content in the audio signal;
responsive to detection of the indicator, modify at least a portion of the audio signal to generate a modified portion of the audio signal; and
provide the audio signal including the modified portion to the speaker for output.

21. The secure audio processor of claim 20, wherein the secure audio processor is configured to modify at least the portion of the audio signal using a modification operation selected substantially randomly from a plurality of modification operations.

22. The secure audio processor of claim 20, wherein the audio signal comprises:
the indicator in a first frequency range of a first portion of the audio signal;
the encoded content in a second frequency range, different from the first frequency range, and distributed across the first portion and a second portion of the audio signal; and
media content in a third frequency range, different from the second frequency range, and distributed across the first portion and the second portion of the audio signal.
